(19) United States
(12) Patent Application Publication
(10) Pub. No.: US 2021/0286107 A1
(43) Pub. Date: Sep. 16, 2021

(54) HARDCOAT FILM AND ARTICLE AND IMAGE DISPLAY DEVICE HAVING HARDCOAT FILM

(71) Applicant: FUJIFILM Corporation, Tokyo (JP)

(72) Inventors: Nobuyuki AKUTAGAWA, Kanagawa (JP); Yuta FUKUSHIMA, Kanagawa (JP)

(73) Assignee: FUJIFILM Corporation, Tokyo (JP)

(21) Appl. No.: 17/329,828

(22) Filed: May 25, 2021

Related U.S. Application Data
(63) Continuation of application No. PCT/JP2019/045877, filed on Nov. 22, 2019.

(30) Foreign Application Priority Data
Nov. 27, 2018 (JP) 2018-221737
Apr. 12, 2019 (JP) 2019-076628

(51) Int. Cl. G02B 1/14; B32B 7/022; C09D 183/04; C09D 7/65; G02B 1/12

(52) U.S. Cl. CPC G02B 1/14; B32B 7/022; G02B 1/12; C09D 7/65; C09D 183/04

(57) ABSTRACT

A hardcoat film includes: a substrate; and a hardcoat layer formed on at least one surface of the substrate, in which the hardcoat layer contains a compound having a silsesquioxane structure, in a case where αA represents a modulus of elasticity of the substrate and σB represents a modulus of elasticity of the hardcoat layer, a difference Δσ of a modulus of elasticity represented by σA−σB is 1,800 to 4,900 MPa, the modulus of elasticity of the substrate is 6.0 to 9.0 GPa, and a recovery rate of the hardcoat layer in an indentation test that is represented by the following equation is 84% to 99%,

$$Recovery rate ( \% ) = \frac{Maximum indentation depth ( μm ) - Depth after unloading ( μm )}{Maximumin indentation depth ( μm )} \times 10 \; 0 .$$

### CROSS REFERENCE TO RELATED APPLICATION

This is a continuation of International Application No. PCT/JP2019/045877 filed on Nov. 22, 2019, and claims priorities from Japanese Patent Application No. 2018-221737 filed on Nov. 27, 2018 and Japanese Patent Application No. 2019-076628 filed on Apr. 12, 2019, the entire disclosures of which are incorporated herein by reference.

### BACKGROUND OF THE INVENTION

### 1. Field of the Invention

The present invention relates to a hardcoat film and an article and an image display device that have the hardcoat film.

### 2. Description of the Related Art

For image display devices such as a display device using a cathode ray tube (CRT), a plasma display panel (PDP), an electroluminescent display (ELD), a vacuum fluorescent display (VFD), a field emission display (FED), and a liquid crystal display (LCD), in order to prevent the display surface from being scratched, it is preferable to provide an optical film (hardcoat film) having a hardcoat layer on a substrate.

For example, JP2017-227898A describes an antireflection film comprising an antireflection layer on a substrate, in which an indentation modulus of elasticity of the surface of the antireflection layer is 20 to 100 GPa.

Furthermore, JP2017-165953A describes that in order to impart impact resistance and folding resistance, a hardcoat composition is used which contains a highly stretchable oligomer having a modulus of elasticity of 10 to 3000 MPa and an elongation at break of 30% to 150%.

### SUMMARY OF THE INVENTION

In recent years, for example, for smartphones and the like, there has been an increasing need for ultra-thin flexible displays. Accordingly, there has been a demand for an optical film that has impact resistance and folding resistance. Particularly, there has been a strong demand for an optical film that simultaneously satisfies high hardness and folding resistance.

As a result of examination, the inventors of the present invention have found that the films described in JP2017-227898A and JP2017-165953A cannot simultaneously satisfy high hardness folding resistance.

An object of the present invention is to provide a hardcoat film which has high hardness and excellent folding resistance and an article and an image display device which comprise the hardcoat film.

As a result of intensive examination, the inventors of the present invention have found that the above object can be achieved by the following means.

<1>

A hardcoat film having a substrate and a hardcoat layer formed on at least one surface of the substrate,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

<2>

The hardcoat film described in <1>, in which a thickness of the hardcoat layer is 0.5 μm to 30 μm.

<3>

The hardcoat film described in <1> or <2>, in which the substrate contains an imide-based polymer.

<4>

The hardcoat film described in any one of <1> to <3>, in which the compound having a silsesquioxane structure is a cured product of a polyorganosilsesquioxane having at least one of a (meth)acryloyl group or an epoxy group.

<5>

The hardcoat film described in any one of <1> to <4>, in which the hardcoat layer contains a compound having a polyrotaxane structure.

<6>

The hardcoat film described in <5>, in which the compound having a polyrotaxane structure is a cured product of a polyrotaxane having at least one of a (meth)acryloyl group or an epoxy group.

<7>

The hardcoat film described in any one of <1> to <6>, in which the hardcoat layer contains a cured product of at least one of a compound (b1) having two or more (meth)acryloyl groups in one molecule, a compound (b2) having two or more epoxy groups in one molecule, a compound (b3) having two or more oxetanyl groups in one molecule, or a blocked isocyanate compound (b4).

<8>

The hardcoat film described in any one of <1> to <7>, further having an anti-scratch layer on the hardcoat layer,

in which the anti-scratch layer contains a cured product of at least one of a compound (c1) having two or more (meth)acryloyl groups in one molecule or a compound (c2) having two or more epoxy groups in one molecule.

<9>

The hardcoat film described in any one of <1> to <8>, further having an adhesive layer between the hardcoat layer and the substrate.

<10>

The hardcoat film described in <9>, further having a mixed layer in which a component of the adhesive layer and a component of the substrate are mixed together between the adhesive layer and the substrate, in which the mixed layer has a thickness of 0.1 μm to 10 μm.

<11>

An article comprising the hardcoat film described in any one of<1> to <10>.

<12>

An image display device comprising the hardcoat film described in any one of <1> to <10> as a surface protection film.

<13>

A method for manufacturing a hardcoat film having a step (1) of coating a temporary support with a composition for forming a hardcoat layer, drying the composition, and then curing the composition so that at least one hardcoat layer is formed on the temporary support,

a step (2) of laminating a substrate on one side of the hardcoat layer that is opposite to the temporary support via an adhesive,

a step (4) of performing heating or active energy ray irradiation so that the hardcoat layer and the substrate stick together, and

a step (5) of peeling the temporary support from the hardcoat layer,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

<14>

The method for manufacturing a hardcoat film described in <13>, further having a step (3) of impregnating the substrate with a part of the adhesive, between the step (2) and the step (4).

<15>

A method for manufacturing a hardcoat film having a step (1′) of coating a temporary support with a composition for forming a hardcoat layer, drying the composition, and then curing the composition so that at least one hardcoat layer is formed on the temporary support,

a step (A) of bonding a protective film to one side of the hardcoat layer that is opposite to the temporary support,

a step (B) of peeling the temporary support from the hardcoat layer,

a step (2′) of laminating a substrate on one side of the hardcoat layer that is opposite to the protective film via an adhesive, and

a step (4′) of performing heating or active energy ray irradiation so that the hardcoat layer and the substrate stick together,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

<16>

The method for manufacturing a hardcoat film described in <15>, further having a step (3′) of impregnating the substrate with a part of the adhesive, between the step (2′) and the step (4′).

<17>

The method for manufacturing a hardcoat film described in <15> or <16>, further having a step (5′) of peeling the protective film from the hardcoat layer.

According to an aspect of the present invention, it is possible to provide a hardcoat film which has high hardness and excellent folding resistance and an article and an image display device which comprise the hardcoat film.

### DESCRIPTION OF THE PREFERRED EMBODIMENTS

Hereinafter, embodiments of the present invention will be specifically described, but the present invention is not limited thereto. In the present specification, in a case where numerical values represent a value of physical properties, a value of characteristics, and the like, the description of “(numerical value 1) to (numerical value 2)” means “equal to or greater than (numerical value 1) and equal to or smaller than (numerical value 2)”. In addition, in the present specification, the description of “(meth)acrylate” means “at least one of acrylate or methacrylate”. The same shall be applied to “(meth)acrylic acid”, “(meth)acryloyl”, and the like.

[Hardcoat Film]

The hardcoat film according to an embodiment of the present invention is

a hardcoat film having a substrate and a hardcoat layer formed on at least one surface of the substrate,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

The hardcoat film according to the embodiment of the present invention has high hardness and excellent folding resistance. Details of the mechanism thereof are unclear, but are assumed to be as below according to the inventors of the present invention.

Presumably, because the hardcoat layer of the hardcoat film according to the embodiment of the present invention contains the compound having a silsesquioxane structure, the hardcoat layer may have a high deformation recovery rate and exhibit high pencil hardness.

Furthermore, presumably, in a case where a difference in a modulus of elasticity between the substrate and the hardcoat layer is controlled within a certain range, when folding stress is applied to the hardcoat film, a difference in an elongation rate between the substrate and the hardcoat layer may be reduced, and excellent folding resistance may also be exhibited. “Folding resistance” means that a hardcoat film having a substrate and a hardcoat layer laminated on the substrate does not crack in a case where the hardcoat layer with the underlying substrate is folded outward along an iron core (mandrel) having a certain diameter (preferably a diameter equal to or less than 6 mm).

<Substrate>

The substrate of the hardcoat film according to the embodiment of the present invention will be described.

The transmittance of the substrate in a visible light region is preferably equal to or higher than 70%, more preferably equal to or higher than 80%, and even more preferably equal to or higher than 90%.

The modulus of elasticity (σA) of the substrate is 6.0 to 9.0 GPa, preferably 7.0 to 9.0 GPa, and more preferably 7.5 to 9.0 GPa.

(Polymer)

The substrate preferably contains a polymer.

As the polymer, a polymer excellent in optical transparency, mechanical strength, heat stability, and the like is preferable.

Examples of such a polymer include polycarbonate-based polymers, polyester-based polymers such as polyethylene terephthalate (PET) and polyethylene naphthalate (PEN), styrene-based polymers such as polystyrene and an acrylonitrile/styrene copolymer (AS resin), and the like. The examples also include polyolefins such as polyethylene and polypropylene, norbornene-based resins, polyolefin-based polymers such as ethylene/propylene copolymers, (meth)acrylic polymers such as polymethyl methacrylate, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, cellulose-based polymers represented by triacetyl cellulose, copolymers of the above polymers, and polymers obtained by mixing together the above polymers.

Particularly, amide-based polymers such as aromatic polyamide and imide-based polymers can be preferably used as the substrate, because the number of times of folding at break measured for these polymers by an MIT tester according to Japanese Industrial Standards (JIS) P8115 (2001) is large, and these polymers have relatively high hardness. For example, the aromatic polyamide described in Example 1 of JP5699454B and the polyimides described in JP2015-508345A, JP2016-521216A, and WO2017/014287A can be preferably used as the substrate.

The substrate can also be formed as a cured layer of an ultraviolet curable resin or a thermosetting resin based on acryl, urethane, acrylic urethane, epoxy, silicone, and the like.

(Softening Material)

The substrate may contain a material that further softens the polymer described above. The softening material refers to a compound that improves the number of times of folding at break. As the softening material, it is possible to use a rubber elastic material, a brittleness improver, a plasticizer, a slide ring polymer, and the like.

Specifically, as the softening material, the softening materials described in paragraphs “0051” to “0114” of JP2016-167043A can be suitability used.

The softening material may be mixed alone with the polymer, or a plurality of softening materials may be appropriately used in combination. Furthermore, the substrate may be prepared using one kind of softening material or a plurality of softening materials without being mixed with the polymer.

That is, the amount of the softening material to be mixed is not particularly limited. A polymer having the sufficient number of times of folding at break itself may be used alone as the substrate of the film or may be mixed with the softening material, or the substrate may be totally (100%) composed of the softening material so that the number of times of folding at break becomes sufficient.

(Other Additives)

Various additives (for example, an ultraviolet absorber, a matting agent, an antioxidant, a peeling accelerator, a retardation (optical anisotropy) regulator, and the like) can be added to the substrate according to the use. These additives may be solids or oily substances. That is, the melting point or boiling point thereof is not particularly limited. In addition, the additives may be added at any point in time in the step of preparing the substrate, and a step of preparing a material by adding additives may be added to a material preparation step. Furthermore, the amount of each material added is not particularly limited as long as each material performs its function.

As those other additives, the additives described in paragraphs “0117” to “0122” of JP2016-167043A can be suitably used.

One kind of each of the above additives may be used singly, or two or more kinds of the above additives can be used in combination.

(Ultraviolet Absorber)

Examples of the ultraviolet absorber include a benzotriazole compound, a triazine compound, and a benzoxazine compound. The benzotriazole compound is a compound having a benzotriazole ring, and specific examples thereof include various benzotriazole-based ultraviolet absorbers described in paragraph “0033” of JP2013-111835A. The triazine compound is a compound having a triazine ring, and specific examples thereof include various triazine-based ultraviolet absorbers described in paragraph “0033” of JP2013-111835A. As the benzoxazine compound, for example, those described in paragraph “0031” of JP2014-209162A can be used. The content of the ultraviolet absorber in the substrate is, for example, about 0.1 to 10 parts by mass with respect to 100 parts by mass of the polymer contained in the substrate, but is not particularly limited. Regarding the ultraviolet absorber, paragraph “0032” of JP2013-111835A can also be referred to. In the present invention, an ultraviolet absorber having high heat resistance and low volatility is preferable. Examples of such an ultraviolet absorber include UVSORB101 (manufactured by FUJIFILM Finechemicals Co., Ltd.), TINUVIN 360, TINUVIN 460, and TINUVIN 1577 (manufactured by BASF SE), LA-F70, LA-31, and LA-46 (manufactured by ADEKA CORPORATION), and the like.

From the viewpoint of transparency, it is preferable that the difference between a refractive index of the softening material and various additives used in the substrate and a refractive index of the polymer be small.

(Substrate Containing Imide-Based Polymer)

As the substrate, a substrate containing an imide-based polymer can be preferably used. In the present specification, the imide-based polymer means a polymer containing at least one or more kinds of repeating structural units represented by Formula (PI), Formula (a), Formula (a′), and Formula (b). Particularly, from the viewpoint of hardness and transparency of the film, it is preferable that the repeating structural unit represented by Formula (PI) be the main structural unit of the imide-based polymer. The amount of the repeating structural unit represented by Formula (PI) with respect to the total amount of the repeating structural units in the imide-based polymer is preferably equal to or greater than 40 mol %, more preferably equal to or greater than 50 mol %, even more preferably equal to or greater than 70 mol %, particularly preferably equal to or greater than 90 mol %, and most preferably equal to or greater than 98 mol %.

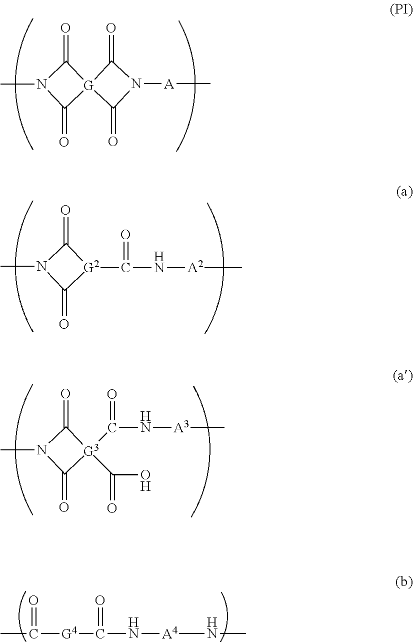

In Formula (PI), G represents a tetravalent organic group, and A represents a divalent organic group. In Formula (a), G² represents a trivalent organic group, and A² represents a divalent organic group. In Formula (a′), G³ represents a tetravalent organic group, and A³ represents a divalent organic group. In Formula (b), G⁴ and A⁴ each represent a divalent organic group.

Examples of the organic group as the tetravalent organic group represented by G in Formula (PI) (hereinafter, sometimes called organic group of G) include a group selected from the group consisting of an acyclic aliphatic group, a cyclic aliphatic group, and an aromatic group. From the viewpoint of transparency and flexibility of the substrate containing the imide-based polymer, the organic group of G is preferably a tetravalent cyclic aliphatic group or a tetravalent aromatic group. Examples of the aromatic group include a monocyclic aromatic group, a condensed polycyclic aromatic group, a non-condensed polycyclic aromatic group having two or more aromatic rings which are linked to each other directly or through a linking group, and the like. From the viewpoint of transparency and coloration inhibition of the substrate, the organic group of G is preferably a cyclic aliphatic group, a cyclic aliphatic group having a fluorine-based substituent, a monocyclic aromatic group having a fluorine-based substituent, a condensed polycyclic aromatic group having a fluorine-based substituent, or a non-condensed polycyclic aromatic group having a fluorine-based substituent. In the present specification, the fluorine-based substituent means a group containing a fluorine atom. The fluorine-based substituent is preferably a fluoro group (fluorine atom, —F) and a perfluoroalkyl group, and more preferably a fluoro group and a trifluoromethyl group.

More specifically, the organic group of G is selected, for example, from a saturated or unsaturated cycloalkyl group, a saturated or unsaturated heterocycloalkyl group, an aryl group, a heteroaryl group, an arylalkyl group, an alkylaryl group, a heteroalkylaryl group, and a group having any two groups (which may be the same as each other) among these that are linked to each other directly or through a linking group. Examples of the linking group include —O—, an alkylene group having 1 to 10 carbon atoms, —SO₂—, —CO—, and —CO—NR— (R represents an alkyl group having 1 to 3 carbon atoms such as a methyl group, an ethyl group, or a propyl group or a hydrogen atom).

The tetravalent organic group represented by G usually has 2 to 32 carbon atoms, preferably has 4 to 15 carbon atoms, more preferably has 5 to 10 carbon atoms, and even more preferably has 6 to 8 carbon atoms. In a case where the organic group of G is a cyclic aliphatic group or an aromatic group, at least one of the carbon atoms constituting these groups may be substituted with a hetero atom. Examples of the hetero atom include O, N, and S.

Specific examples of G include groups represented by Formula (20), Formula (21), Formula (22), Formula (23), Formula (24), formula (25), or Formula (26). * in each formula represents a bond. In Formula (26), Z represents a single bond, —O—, —CH₂—, —C(CH₃)₂—, —Ar—O—Ar—, —Ar—CH₂—Ar—, —Ar—C(CH₃)₂—Ar—, or —Ar—SO₂—Ar—. Ar represents an aryl group having 6 to 20 carbon atoms. Ar may be, for example, a phenylene group. At least one of the hydrogen atoms in these groups may be substituted with a fluorine-based substituent.

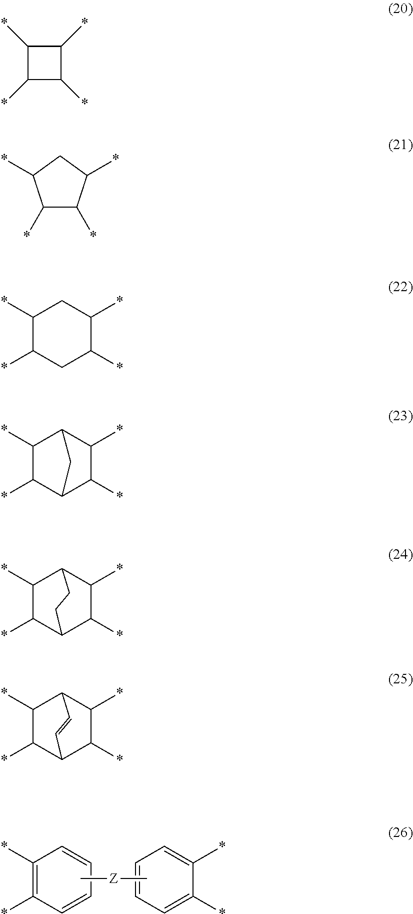

Examples of the organic group as the divalent organic group represented by A in Formula (PI) (hereinafter, sometimes called organic group of A) include a group selected from the group consisting of an acyclic aliphatic group, a cyclic aliphatic group, and an aromatic group. The divalent organic group represented by A is preferably selected from a divalent cyclic aliphatic group and a divalent aromatic group. Examples of the aromatic group include a monocyclic aromatic group, a condensed polycyclic aromatic group, and a non-condensed polycyclic aromatic group having two or more aromatic rings which are linked to each other directly or through a linking group. From the viewpoint of transparency and coloration inhibition of the substrate, it is preferable that a fluorine-based substituent be introduced into the organic group of A.

More specifically, the organic group of A is selected, for example, from a saturated or unsaturated cycloalkyl group, a saturated or unsaturated heterocycloalkyl group, an aryl group, a heteroaryl group, an arylalkyl group, an alkylaryl group, a heteroalkylaryl group, and a group having any two groups (which may be the same as each other) among these that are linked to each other directly or through a linking group. Examples of the hetero atom include O, N, and S. Examples of the linking group include —O—, an alkylene group having 1 to 10 carbon atoms, —SO₂—, —CO—, and —CO—NR— (R represents an alkyl group having 1 to 3 carbon atoms such as a methyl group, an ethyl group, or a propyl group or a hydrogen atom).

The divalent organic group represented by A usually has 2 to 40 carbon atoms, preferably has 5 to 32 carbon atoms, more preferably has 12 to 28 carbon atoms, and even more preferably has 24 to 27 carbon atoms.

Specific examples of A include groups represented by Formula (30), Formula (31), Formula (32), Formula (33), or Formula (34). * in each formula represents a bond. Z¹ to Z³ each independently represent a single bond, —O—, —CH₂—, —C(CH₃)₂—, —SO₂—, —CO—, or —CO—NR— (R represents an alkyl group having 1 to 3 carbon atoms such as a methyl group, an ethyl group, or a propyl group or a hydrogen atom). In the following groups, Z¹ and Z² as well as Z² and Z³ are preferably in the meta position or para position respectively for each ring. Furthermore, it is preferable that Z¹ and a terminal single bond, Z² and a terminal single bond, and Z³ and a terminal single bond be in the meta position or para position respectively. For example, in A, Z¹ and Z³ represent —O—, and Z² represents —CH₂—, —C(CH₃)₂—, or —SO₂—. One hydrogen atom or two or more hydrogen atoms in these groups may be substituted with a fluorine-based substituent.

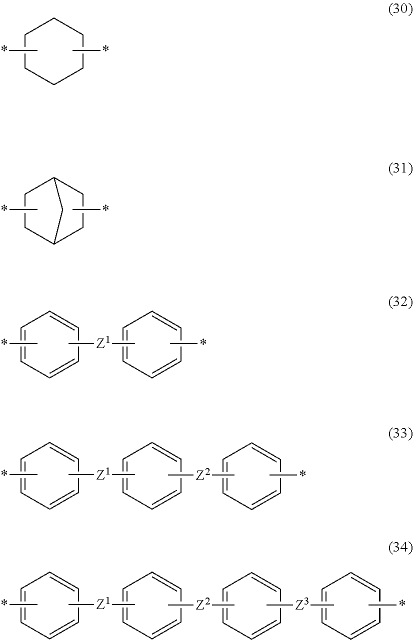

At least one of the hydrogen atoms constituting at least one of A or G may be substituted with at least one kind of functional group selected from the group consisting of a fluorine-based substituent, a hydroxyl group, a sulfone group, an alkyl group having 1 to 10 carbon atoms, and the like. Furthermore, in a case where each of the organic group of A and the organic group of G is a cyclic aliphatic group or an aromatic group, it is preferable that at least one of A or G have a fluorine-based substituent, and it is more preferable that both the A and G have a fluorine-based substituent.

G² in Formula (a) represents a trivalent organic group. This organic group can be selected from the same group as the organic group of G in formula (PI), except that G² is a trivalent group. Examples of G² include groups represented by Formula (20) to Formula (26) listed above as specific examples of G in which any one of the four bonds is substituted with a hydrogen atom. A2 in Formula (a) can be selected from the same group as A in Formula (PI).

G³ in Formula (a′) can be selected from the same group as G in Formula (PI). A³ in Formula (a′) can be selected from the same group as A in Formula (PI).

G⁴ in Formula (b) represents a divalent organic group. This organic group can be selected from the same group as the organic group of G in formula (PI), except that G⁴ is a divalent group. Examples of G⁴ include groups represented by Formula (20) to Formula (26) listed above as specific examples of G in which any two of the four bonds are substituted with a hydrogen atom. A⁴ in Formula (b) can be selected from the same group as A in Formula (PI).

The imide-based polymer contained in the substrate containing the imide-based polymer may be a condensed polymer obtained by the polycondensation of diamines and at least one kind of tetracarboxylic acid compound (including a tetracarboxylic acid compound analog such as an acid chloride compound or a tetracarboxylic dianhydride) or one kind of tricarboxylic acid compound (including a tricarboxylic acid compound analog such as an acid chloride compound or a tricarboxylic anhydride). Furthermore, a dicarboxylic acid compound (including an analog such as an acid chloride compound) may also take part in the polycondensation. The repeating structural unit represented by Formula (PI) or Formula (a′) is usually derived from diamines and a tetracarboxylic acid compound. The repeating structural unit represented by Formula (a) is usually derived from diamines and a tricarboxylic acid compound. The repeating structural unit represented by Formula (b) is usually derived from diamines and a dicarboxylic acid compound.

Examples of the tetracarboxylic acid compound include an aromatic tetracarboxylic acid compound, an alicyclic tetracarboxylic acid compound, an acyclic aliphatic tetracarboxylic acid compound, and the like. Two or more kinds of these compounds may be used in combination. The tetracarboxylic acid compound is preferably tetracarboxylic dianhydride. Examples of the tetracarboxylic dianhydride include an aromatic tetracarboxylic dianhydride, an alicyclic tetracarboxylic dianhydride, and an acyclic aliphatic tetracarboxylic dianhydride.

From the viewpoint of solubility of the imide-based polymer in a solvent and from the viewpoint of transparency and flexibility of the formed substrate, the tetracarboxylic acid compound is preferably an alicyclic tetracarboxylic acid compound, an aromatic tetracarboxylic acid compound, or the like. From the viewpoint of transparency and coloration inhibition of the substrate containing the imide-based polymer, the tetracarboxylic acid compound is preferably a compound selected from an alicyclic tetracarboxylic acid compound having a fluorine-based substituent and an aromatic tetracarboxylic acid compound having a fluorine-based substituent, and more preferably an alicyclic tetracarboxylic acid compound having a fluorine-based substituent.

Examples of the tricarboxylic acid compound include an aromatic tricarboxylic acid, an alicyclic tricarboxylic acid, an acyclic aliphatic tricarboxylic acid, an acid chloride compound or an acid anhydride that is structurally similar to these, and the like. The tricarboxylic acid compound is preferably selected from an aromatic tricarboxylic acid, an alicyclic tricarboxylic acid, an acyclic aliphatic tricarboxylic acid, and an acid chloride compound that is structurally similar to these. Two or more kinds of tricarboxylic acid compounds may be used in combination.

From the viewpoint of solubility of the imide-based polymer in a solvent and from the viewpoint of transparency and flexibility of the formed substrate containing the imide-based polymer, the tricarboxylic acid compound is preferably an alicyclic tricarboxylic acid compound or an aromatic tricarboxylic acid compound. From the viewpoint of transparency and coloration inhibition of the substrate containing the imide-based polymer, the tricarboxylic acid compound is more preferably an alicyclic tricarboxylic acid compound having a fluorine-based substituent or an aromatic tricarboxylic acid compound having a fluorine-based substituent.

Examples of the dicarboxylic acid compound include an aromatic dicarboxylic acid, an alicyclic dicarboxylic acid, an acyclic aliphatic dicarboxylic acid, an acid chloride compound or an acid anhydride that is structurally similar to these, and the like. The dicarboxylic acid compound is preferably selected from an aromatic dicarboxylic acid, an alicyclic dicarboxylic acid, an acyclic aliphatic dicarboxylic acid, and an acid chloride compound that is structurally similar to these. Two or more kinds of dicarboxylic acid compounds may be used in combination.

From the viewpoint of solubility of the imide-based polymer in a solvent and from the viewpoint of transparency and flexibility of the formed substrate containing the imide-based polymer, the dicarboxylic acid compound is preferably an alicyclic dicarboxylic acid compound or an aromatic dicarboxylic acid compound. From the viewpoint of transparency and coloration inhibition of the substrate containing the imide-based polymer, the dicarboxylic acid compound is more preferably an alicyclic dicarboxylic acid compound having a fluorine-based substituent or an aromatic dicarboxylic acid compound having a fluorine-based substituent.

Examples of the diamines include an aromatic diamine, an alicyclic diamine, and an aliphatic diamine. Two or more kinds of these may be used in combination. From the viewpoint of solubility of the imide-based polymer in a solvent and from the viewpoint of transparency and flexibility of the formed substrate containing the imide-based polymer, the diamines are preferably selected from an alicyclic diamine and an aromatic diamine having a fluorine-based substituent.

In a case where such an imide-based polymer is used, it is easy to obtain a substrate having particularly excellent flexibility, high light transmittance (for example, equal to or higher than 85% and preferably equal to or higher than 88% for light at 550 nm), low yellowness (YI value that is equal to or lower than 5 and preferably equal to or lower than 3), and low haze (equal to or lower than 1.5% and preferably equal to or lower than 1.0%).

The imide-based polymer may be a copolymer containing a plurality of different kinds of repeating structural units described above. The weight-average molecular weight of the polyimide-based polymer is generally 10,000 to 500,000. The weight-average molecular weight of the imide-based polymer is preferably 50,000 to 500,000, and more preferably 70,000 to 400,000. The weight-average molecular weight is a molecular weight measured by gel permeation chromatography (GPC) and expressed in terms of standard polystyrene. In a case where the weight-average molecular weight of the imide-based polymer is large, high flexibility tends to be easily obtained. However, in a case where the weight-average molecular weight of the imide-based polymer is too large, the viscosity of varnish increases, and hence workability tends to deteriorate.

The imide-based polymer may contain a halogen atom such as a fluorine atom which can be introduced into the polymer by the aforementioned fluorine-based substituent or the like. In a case where the polyimide-based polymer contains a halogen atom, the modulus of elasticity of the substrate containing the imide-based polymer can be improved, and the yellowness can be reduced. As a result, the occurrence of scratches, wrinkles, and the like in the hardcoat film can be inhibited, and the transparency of the substrate containing the imide-based polymer can be improved. The halogen atom is preferably a fluorine atom. The content of the halogen atom in the polyimide-based polymer based on the mass of the polyimide-based polymer is preferably 1% to 40% by mass, and more preferably 1% to 30% by mass.

The substrate containing the imide-based polymer may contain one kind of ultraviolet absorber or two or more kinds of ultraviolet absorbers. The ultraviolet absorber can be appropriately selected from compounds that are generally used as ultraviolet absorbers in the field of resin materials. The ultraviolet absorber may include a compound that absorbs light having a wavelength equal to or shorter than 400 nm. Examples of the ultraviolet absorber that can be appropriately combined with the imide-based polymer include at least one kind of compound selected from the group consisting of a benzophenone-based compound, a salicylate-based compound, a benzotriazole-based compound, and a triazine-based compound.

In the present specification, “-based compound” means a derivative of the compound following “-based”. For example, “benzophenone-based compound” refers to a compound having benzophenone as a base skeleton and a substituent bonded to the benzophenone.

The content of the ultraviolet absorber with respect to the total mass of the substrate is generally equal to or greater than 1% by mass, preferably equal to or greater than 2% by mass, and more preferably equal to or greater than 3% by mass. The content of the ultraviolet absorber with respect to the total mass of the substrate is generally equal to or smaller than 10% by mass, preferably equal to or smaller than 8% by mass, and even more preferably equal to or smaller than 6% by mass. In a case where the content of the ultraviolet absorber is within the above range, the weather fastness of the substrate can be improved.

The substrate containing the imide-based polymer may further contain an inorganic material such as inorganic particles. The inorganic material is preferably a silicon material containing silicon atoms. In a case where the substrate containing the imide-based polymer contains an inorganic material such as silicon material, it is easy to set the tensile modulus of elasticity of the substrate containing the imide-based polymer to a value equal to or higher than 4.0 GPa. However, mixing the substrate containing the imide-based polymer with an inorganic material is not the only way to control the tensile modulus of elasticity of the substrate.

Examples of the silicon material containing silicon atoms include silica particles, quaternary alkoxysilane such as tetraethyl orthosilicate (TEOS), and a silicon compound such as a silsesquioxane derivative. Among these silicon materials, from the viewpoint of transparency and flexibility of the substrate containing the imide-based polymer, silica particles are preferable.

The average primary particle size of the silica particles is generally equal to or smaller than 100 nm. In a case where the average primary particle size of the silica particles is equal to or smaller than 100 nm, the transparency tends to be improved.

The average primary particle size of the silica particles in the substrate containing the imide-based polymer can be determined by the observation with a transmission electron microscope (TEM). As the primary particle size of the silica particles, the Feret's diameter measured using a transmission electron microscope (TEM) can be adopted. The average primary particle size can be determined by measuring primary particle sizes at 10 spots by TEM observation and calculating the average thereof. The particle size distribution of the silica particles that have not yet form the substrate containing the imide-based polymer can be determined using a commercially available laser diffraction particle size distribution analyzer.

In the substrate containing the imide-based polymer, in a case where the total amount of the imide-based polymer and the inorganic material is regarded as 10, the mixing ratio of imide-based polymer:inorganic material based on mass is preferably 1:9 to 10:0, more preferably 3:7 to 10:0, even more preferably 3:7 to 8:2, and still more preferably 3:7 to 7:3. The ratio of the inorganic material to the total mass of the imide-based polymer and the inorganic material is generally equal to or higher than 20% by mass, and preferably equal to or higher than 30% by mass. The ratio of the inorganic material to the total mass of the imide-based polymer and the inorganic material is generally equal to or lower than 90% by mass, and preferably equal to or lower than 70% by mass. In a case where the mixing ratio of imide-based polymer:inorganic material (silicon material) is within the above range, the transparency and mechanical strength of the substrate containing the imide-based polymer tend to be improved. Furthermore, it is easy to set the tensile modulus of elasticity of the substrate containing the imide-based polymer to a value equal to or higher than 4.0 GPa.

As long as the transparency and flexibility are not markedly impaired, the substrate containing the imide-based polymer may further contain components other than the imide-based polymer and the inorganic material. Examples of components other than the imide-based polymer and the inorganic material include an antioxidant, a release agent, a stabilizer, a coloring agent such as a bluing agent, a flame retardant, a lubricant, a thickener, and a leveling agent. The ratio of components other than the imide-based polymer and the inorganic material to the mass of the substrate is preferably higher than 0% and equal to or lower than 20% by mass, and more preferably higher than 0% and equal to or lower than 10% by mass.

In a case where the substrate containing the imide-based polymer contains the imide-based polymer and the silicon material, Si/N which represents a ratio of the number of silicon atoms to the number of nitrogen atoms within at least one surface is preferably equal to or higher than 8. Si/N which represents the ratio of the number of atoms is a value calculated from the abundance of silicon atoms and the abundance of nitrogen atoms that are obtained by evaluating the composition of the substrate containing the imide-based polymer by X-ray photoelectron spectroscopy (XPS).

In a case where Si/N within at least one surface of the substrate containing the imide-based polymer is equal to or higher than 8, sufficient adhesiveness between the substrate and a hardcoat layer is obtained. From the viewpoint of adhesiveness, Si/N is more preferably equal to or higher than 9, and even more preferably equal to or higher than 10. Si/N is preferably equal to or lower than 50, and more preferably equal to or lower than 40.

(Thickness of Substrate)

The substrate is in the form of a film. The thickness of the substrate is more preferably equal to or smaller than 100 μm, even more preferably equal to or smaller than 80 μm, and most preferably equal to or smaller than 50 μm. In a case where the substrate has a small thickness, the difference in curvature between the front surface and the back surface of the folded substrate is reduced. Therefore, cracks and the like hardly occur, and the substrate is hardly broken even being folded plural times. On the other hand, from the viewpoint of ease of handling of the substrate, the thickness of the substrate is preferably equal to or greater than 3 μm, more preferably equal to or greater than 5 μm, and most preferably equal to or greater than 15 μm.

(Method for Preparing Substrate)

The substrate may be prepared by heat-melting a thermoplastic polymer, or may be prepared from a solution, in which a polymer is uniformly dissolved, by solution film formation (a solvent casting method). In the case of heat-melting film formation, the softening material and various additives described above can be added during heat melting. In contrast, in a case where the substrate is prepared by the solution film formation method, the softening material and various additives described above can be added to the polymer solution (hereinafter, also called dope) in each preparation step. Furthermore, the softening material and various additives may be added at any point in time in a dope preparation process. In the dope preparation process, a step of preparing the dope by adding the additives may be additionally performed as a final preparation step.

In order to dry and/or bake the coating film, the coating film may be heated. The heating temperature of the coating film is generally 50° C. to 350° C. The coating film may be heated in an inert atmosphere or under reduced pressure. By the heating of the coating film, solvents can be evaporated and removed. The substrate may be formed by a method including a step of drying the coating film at 50° C. to 150° C. and a step of baking the dried coating film at 180° C. to 350° C.

A surface treatment may be performed on at least one surface of the substrate.

<Hardcoat Layer>

The hardcoat layer of the hardcoat film according to the embodiment of the present invention will be described.

The hardcoat layer is formed on at least one surface of the substrate.

(Compound Having Silsesquioxane Structure)

The hardcoat layer contains a compound having a silsesquioxane structure.

“Silsesquioxane structure” means a structure composed of siloxane bonds (Si—O—Si) in a silsesquioxane.

A polyorganosilsesquioxane is a network-type polymer or polyhedral cluster having a siloxane constitutional unit derived from a hydrolyzable trifunctional silane compound, and can form a random structure, a ladder structure, a cage structure, and the like by a siloxane bond. In the present invention, although the silsesquioxane structure may be any of the above structures, it is preferable that the silsesquioxane structure contain many ladder structures. In a case where the ladder structure is formed, the deformation recovery of the hardcoat film can be excellently maintained. Whether the ladder structure is formed can be qualitatively determined by checking whether or not absorption occurs which results from Si—O—Si expansion/contraction unique to the ladder structure found at around 1,020 to 1,050 cm⁻¹ by Fourier Transform Infrared Spectroscopy (FT-IR).

Furthermore, in the present invention, “compound having a silsesquioxane structure” may be a silsesquioxane, a compound composed of two or more polyorganosilsesquioxanes bonded together (for example, a cured product of a polyorganosilsesquioxane having a polymerizable group), or a cured product of a polyorganosilsesquioxane having a polymerizable group and another polymerizable compound. That is, “compound having a silsesquioxane structure” also includes a polymer having a three-dimensional network structure and a matrix of a hardcoat layer.

From the viewpoint of hardness and folding resistance, the compound having a silsesquioxane structure is preferably a cured product of a polyorganosilsesquioxane having a polymerizable group. The cured product of a polyorganosilsesquioxane having a polymerizable group is preferably obtained by curing a composition containing a polyorganosilsesquioxane having a polymerizable group by at least either heating or irradiation with ionizing radiation.

(Polyorganosilsesquioxane (A) Having Polymerizable Group)

The polymerizable group in the polyorganosilsesquioxane (A) having a polymerizable group (also called “polyorganosilsesquioxane (A)”) is not particularly limited, but is preferably a radically or cationically polymerizable group.

As the radically polymerizable group, a generally known radically polymerizable group can be used. For example, a vinyl group and a (meth)acryloyl group are suitable as the radically polymerizable group. Particularly, a (meth)acryloyl group is preferable.

As the cationically polymerizable group, a generally known cationically polymerizable group can be used. Specifically, examples thereof include an alicyclic ether group, a cyclic acetal group, a cyclic lactone group, a cyclic thioether group, a spiro-orthoester group, a vinyloxy group, and the like. Among these, an alicyclic ether group and a vinyloxy group are suitable, an epoxy group, an oxetanyl group, and a vinyloxy group are particularly preferable, and an epoxy group is mostly preferably used.

The compound having a silsesquioxane structure is preferably a cured product of a polyorganosilsesquioxane having at least one of a (meth)acryloyl group or an epoxy group.

The polyorganosilsesquioxane (A) having a polymerizable group is preferably a polyorganosilsesquioxane (a1) having an epoxy group or a polyorganosilsesquioxane (a2) having a (meth)acryloyl group.

(Polyorganosilsesquioxane (a1) Having Epoxy Group)

The polyorganosilsesquioxane (a1) having an epoxy group (also called “polyorganosilsesquioxane (a1)”) is preferably a polyorganosilsesquioxane which has at least a siloxane constitutional unit containing an epoxy group and is represented by General Formula (1).

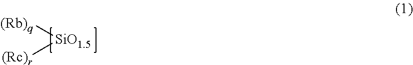

In General Formula (1), Rb represents a group containing an epoxy group, and Rc represents a monovalent group. q and r each represent a proportion of each of Rb and Rc in General Formula (1), q+r=100, q is greater than 0, and r is equal to or greater than 0. In a case where there is a plurality of Rb's and Rc's in General Formula (1), the plurality of Rb's and Rc's may be the same as or different from each other respectively. In a case where there is a plurality of Rc's in General Formula (1), the plurality of Rc's may form a bond with each other.

[SiO_{1.5}] in General Formula (1) represents a structural portion composed of a siloxane bond (Si—O—Si) in the polyorganosilsesquioxane.

The polyorganosilsesquioxane is a network-type polymer or polyhedral cluster having a siloxane constitutional unit derived from a hydrolyzable trifunctional silane compound, and can form a random structure, a ladder structure, a cage structure, and the like by a siloxane bond. In the present invention, although the structural portion represented by [SiO _{1.5}] may be any of the above structures, it is preferable that the structural portion contain many ladder structures. In a case where the ladder structure is formed, the deformation recovery of the hardcoat film can be excellently maintained. Whether the ladder structure is formed can be qualitatively determined by checking whether or not absorption occurs which results from Si—O—Si expansion/contraction unique to the ladder structure found at around 1,020 to 1,050 cm⁻¹ by Fourier Transform Infrared Spectroscopy (FT-IR).

In General Formula (1), Rb represents a group containing an epoxy group.

Examples of the group containing an epoxy group include known groups having an oxirane ring.

Rb is preferably a group represented by Formulas (1b) to (4b).

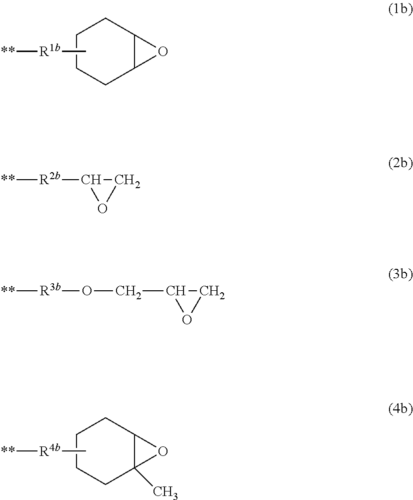

In Formulas (1b) to (4b), ** represents a portion linked to Si in General Formula (1), and R^{1b}, R^{2b}, R^{3b}, and R^{4b} represent a substituted or unsubstituted alkylene group.

The alkylene group represented by R^{1b}, R^{2b}, R^{3b}, and R^{4b} is preferably a linear or branched alkylene group having 1 to 10 carbon atoms, and examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by R^{1b}, R^{2b}, R^{3b}, and R^{4b} has a substituent, examples of the substituent include a hydroxyl group, a carboxyl group, an alkoxy group, an aryl group, a heteroaryl group, a halogen atom, a nitro group, a cyano group, a silyl group, and the like.

As R^{1b}, R^{2b}, R^{3b} and R^{4b}, an unsubstituted linear alkylene group having 1 to 4 carbon atoms and an unsubstituted branched alkylene group having 3 or 4 carbon atoms are preferable, an ethylene group, a n-propylene group, or an i-propylene group is more preferable, and an ethylene group or an n-propylene group is even more preferable.

Rb in the General Formula (1) is preferably a group having a glycidyl group, and more preferably a group represented by Formula (2b) described above. Rb in General Formula (1) may be a group having an alicyclic epoxy group. From the viewpoint of controlling the modulus of elasticity of the hardcoat layer, a content rate of a polyorganosilsesquioxane comprising a group having an alicyclic epoxy group in the total solid content of the composition for forming a hardcoat layer is preferably equal to or lower than 30% by mass, more preferably equal to or lower than 20% by mass, and even more preferably equal to or lower than 10% by mass.

Rb in General Formula (1) is derived from a group (a group other than an alkoxy group and a halogen atom; for example, Rb in a hydrolyzable silane compound represented by Formula (B) which will be described later, or the like) bonded to a silicon atom in the hydrolyzable trifunctional silane compound used as a raw material of the polyorganosilsesquioxane.

Specific examples of Rb are as below, but the present invention is not limited thereto. In the following specific examples, ** represents a portion linked to Si in General Formula (1).

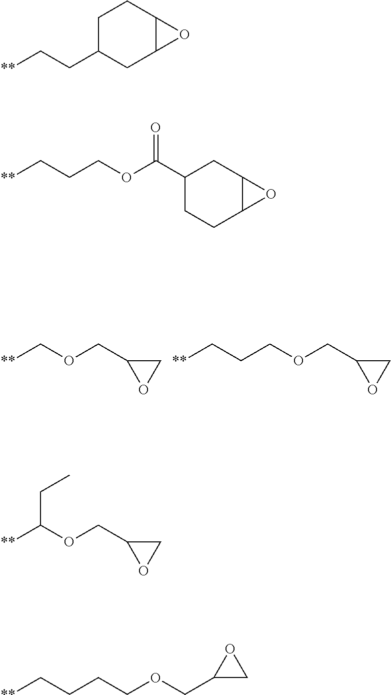

In General Formula (1), Rc represents a monovalent group.

Examples of the monovalent group represented by Rc include a hydrogen atom, a substituted or unsubstituted alkyl group, a substituted or unsubstituted cycloalkyl group, a substituted or unsubstituted alkenyl group, a substituted or unsubstituted aryl group, or a substituted or unsubstituted aralkyl group.

Examples of the alkyl group represented by Rc include an alkyl group having 1 to 10 carbon atoms. Examples thereof include linear or branched alkyl groups such as a methyl group, an ethyl group, a propyl group, a n-butyl group, an isopropyl group, an isobutyl group, a s-butyl group, a t-butyl group, and an isopentyl group.

Examples of the cycloalkyl group represented by Rc include a cycloalkyl group having 3 to 15 carbon atoms. Examples thereof include a cyclobutyl group, a cyclopentyl group, a cyclohexyl group, and the like.

Examples of the alkenyl group represented by Rc include an alkenyl group having 2 to 10 carbon atoms. Examples of the alkenyl group include a linear or branched alkenyl group such as a vinyl group, an allyl group, or an isopropenyl group.

Examples of the aryl group represented by Rc include an aryl group having 6 to 15 carbon atoms. Examples thereof include a phenyl group, a tolyl group, a naphthyl group, and the like.

Examples of the aralkyl group represented by Rc include an aralkyl group having 7 to 20 carbon atoms. Examples thereof include a benzyl group, a phenethyl group, and the like.

Examples of the substituted alkyl group, substituted cycloalkyl group, substituted alkenyl group, substituted aryl group, and substituted aralkyl group described above include groups obtained in a case where some or all of hydrogen atoms or main chain skeletons in the alkyl group, cycloalkyl group, alkenyl group, aryl group, and aralkyl group described above are substituted with at least one kind of group selected from the group consisting of an ether group, an ester group, a carbonyl group, a halogen atom (such as a fluorine atom), an acryloyl group, a methacryloyl group, a mercapto group, and a hydroxy group (hydroxyl group), and the like.

Rc is preferably a substituted or unsubstituted alkyl group, and more preferably an unsubstituted alkyl group having 1 to 10 carbon atoms.

In a case where there is a plurality of Rc's in General Formula (1), the plurality of Rc's may form a bond with each other. The number of Rc's forming a bond with each other is preferably 2 or 3, and more preferably 2.

A group (Rc₂) formed by the bonding of two Rc's is preferably an alkylene group formed by the bonding of the aforementioned substituted or unsubstituted alkyl groups represented by Rc.

Examples of the alkylene group represented by Rc₂ include linear or branched alkylene groups such as a methylene group, an ethylene group, a propylene group, an isopropylene group, a n-butylene group, an isobutylene group, a s-butylene group, a t-butylene group, a n-pentylene group, an isopentylene group, a s-pentylene group, a t-pentylene group, a n-hexylene group, an isohexylene group, a s-hexylene group, a t-hexylene group, a n-heptylene group, an isoheptylene group, a s-heptylene group, a t-heptylene group, a n-octylene group, an isooctylene group, a s-octylene group, and a t-octylene group.

The alkylene group represented by Rc₂ is preferably an unsubstituted alkylene group having 2 to 20 carbon atoms, more preferably an unsubstituted alkylene group having 2 to 10 carbon atoms, even more preferably an unsubstituted alkylene group having 2 to 8 carbon atoms, and particularly preferably a n-butylene group, a n-pentylene group, a n-hexylene group, a n-heptylene group, or a n-octylene group.

A group (Rc₃) formed by the bonding of three Rc's is preferably a trivalent group obtained in a case where any one of the hydrogen atoms in the alkylene group represented by Rc₂ is removed.

Rc in General Formula (1) is derived from a group (a group other than an alkoxy group and a halogen atom; for example, R_{c1} to R_{c3} in a hydrolyzable silane compound represented by Formulas (C1) to (C3) which will be described later, or the like) bonded to a silicon atom in the hydrolyzable silane compound used as a raw material of the polyorganosilsesquioxane.

In General Formula (1), q is greater than 0, and r is equal to or greater than 0.

q/(q+r) is preferably 0.5 to 1.0. In a case where the amount of the group represented by Rb is equal to or greater than 50% of the total amount of the groups represented by Rb and Rc contained in the polyorganosilsesquioxane (a1), the network composed of organic crosslinking groups is sufficiently formed. Therefore, the performances such as hardness and resistance to repeated folding can be excellently maintained.

q/(q+r) is more preferably 0.7 to 1.0, even more preferably 0.9 to 1.0, and particularly preferably 0.95 to 1.0.

It is also preferable that there is a plurality of Rc's in General Formula (1), and the plurality of Rc's form a bond with each other. In this case, r/(q+r) is preferably 0.005 to 0.20.

r/(q+r) is more preferably 0.005 to 0.10, even more preferably 0.005 to 0.05, and particularly preferably 0.005 to 0.025.

The number-average molecular weight (Mn) of the polyorganosilsesquioxane (a1) that is measured by gel permeation chromatography (GPC) and expressed in terms of standard polystyrene is preferably 500 to 6,000, more preferably 1,000 to 4,500, and even more preferably 1,500 to 3,000.

The molecular weight dispersity (Mw/Mn) of the polyorganosilsesquioxane (a1) that is measured by GPC and expressed in terms of standard polystyrene is, for example, 1.0 to 4.0, preferably 1.1 to 3.7, more preferably 1.2 to 3.0, and even more preferably 1.3 to 2.5. Mn represents a number-average molecular weight.

The weight-average molecular weight and the molecular weight dispersity of the polyorganosilsesquioxane (a1) were measured using the following device under the following conditions.

Measurement device: trade name “LC-20AD” (manufactured by Shimadzu Corporation)

Columns: two Shodex KF-801 columns, KF-802, and KF-803 (manufactured by SHOWA DENKO K.K.)

Measurement temperature: 40° C.

Eluent: tetrahydrofuran (THF), sample concentration of 0.1% to 0.2% by mass

Flow rate: 1 mL/min

Detector: UV-VIS detector (trade name “SPD-20A”, manufactured by Shimadzu Corporation)

Molecular weight: expressed in terms of standard polystyrene

<Method for Manufacturing Polyorganosilsesquioxane (a1)>

The polyorganosilsesquioxane (a1) can be manufactured by a known manufacturing method and is not particularly limited. The polyorganosilsesquioxane (a1) can be manufactured preferably by a method of hydrolyzing and condensing one kind of hydrolyzable silane compound or two or more kinds of hydrolyzable silane compounds. As the hydrolyzable silane compound, it is preferable to use a hydrolyzable trifunctional silane compound (a compound represented by Formula (B)) for forming a siloxane constitutional unit containing an epoxy group.

In a case where r in General Formula (1) is greater than 0, as the hydrolyzable silane compounds, it is preferable to use the compounds represented by Formula (C1), (C2), or (C3) in combination.

Rb—Si(X²)₃ (B)

Rb in Formula (B) has the same definition as Rb in General Formula (1), and preferred examples thereof are also the same.

X² in Formula (B) represents an alkoxy group or a halogen atom.

Examples of the alkoxy group represented by X² include an alkoxy group having 1 to 4 carbon atoms such as a methoxy group, an ethoxy group, a propoxy group, an isopropyloxy group, a butoxy group, and an isobutyloxy group.

Examples of the halogen atom represented by X² include a fluorine atom, a chlorine atom, a bromine atom, an iodine atom, and the like.

As X², an alkoxy group is preferable, and a methoxy group and an ethoxy group are more preferable. Three X²'s may be the same as or different from each other.

The compound represented by Formula (B) is a compound forming a siloxane constitutional unit having Rb.

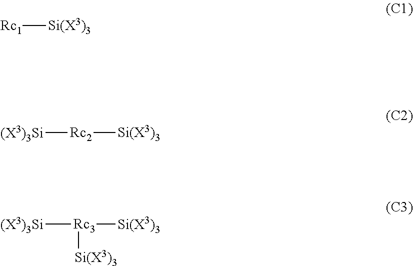

Rc₁ in Formula (C1) has the same definition as Rc in General Formula (1), and preferred examples thereof are also the same.

Rc₂ in Formula (C2) has the same definition as the group (Rc₂) formed in a case where two Rc's in General Formula (1) are bonded to each other, and preferred examples thereof are also the same.

Rc₃ in Formula (C3) has the same definition as the group (Rc₃) formed in a case where three Rc's in General Formula (1) are bonded to each other, and preferred examples thereof are also the same.

X³ in Formulas (C1) to (C3) has the same definition as X² in Formula (B), and preferred examples thereof are also the same. The plurality of X³'s may be the same as or different from each other.

As the hydrolyzable silane compound, hydrolyzable silane compounds other than the compounds represented by Formulas (B) and (C1) to (C3) may be used in combination. Examples thereof include a hydrolyzable trifunctional silane compound, a hydrolyzable monofunctional silane compound, a hydrolyzable difunctional silane compound, and the like other than the compounds represented by Formulas (B) and (C1) to (C3).

In a case where Rc is derived from Rc₁ to Rc₃ in the hydrolyzable silane compounds represented by Formulas (C1) to (C3), in order to adjust q/(q+r) in General Formula (1), a mixing ratio (molar ratio) among the compounds represented by Formulas (B) and (C1) to (C3) may be adjusted.

Specifically, for example, in order to adjust q/(q+r) to 0.5 to 1.0, a value represented by the following (Z2) may be set to 0.5 to 1.0, and a method of hydrolyzing and condensing these compounds may be used to manufacture the polyorganosilsesquioxane (a1).

(Z2)={compound represented by Formula (B) (molar amount)}/{compound represented by Formula (B) (molar amount)+compound represented by Formula (C1) (molar amount)+compound represented by Formula (C2) (molar amount)×2+compound represented by Formula (C3) (molar amount)×3}

The amount of the above hydrolyzable silane compounds used and the composition thereof can be appropriately adjusted depending on the desired structure of the polyorganosilsesquioxane (a1).

Furthermore, the hydrolysis and condensation reactions of the hydrolyzable silane compounds can be performed simultaneously or sequentially. In a case where the above reactions are sequentially performed, the order of performing the reactions is not particularly limited.

The hydrolysis and condensation reactions of the hydrolyzable silane compounds can be carried out in the presence or absence of a solvent, and are preferably carried out in the presence of a solvent.

Examples of the solvent include aromatic hydrocarbons such as benzene, toluene, xylene, and ethylbenzene; ethers such as diethyl ether, dimethoxyethane, tetrahydrofuran, and dioxane; ketones such as acetone, methyl ethyl ketone, and methyl isobutyl ketone; esters such as methyl acetate, ethyl acetate, isopropyl acetate, and butyl acetate; amides such as N,N-dimethylformamide and N,N-dimethylacetamide; nitriles such as acetonitrile, propionitrile, and benzonitrile; alcohols such as methanol, ethanol, isopropyl alcohol, and butanol, and the like.

As the solvent, ketones or ethers are preferable. One kind of solvent can be used singly, or two or more kinds of solvents can be used in combination.

The amount of the solvent used is not particularly limited, and can be appropriately adjusted depending on the desired reaction time or the like so that the amount falls into a range of 0 to 2,000 parts by mass with respect to the total amount (100 parts by mass) of the hydrolyzable silane compounds.

The hydrolysis and condensation reactions of the hydrolyzable silane compounds are preferably performed in the presence of a catalyst and water. The catalyst may be an acid catalyst or an alkali catalyst.

Examples of the acid catalyst include mineral acids such as hydrochloric acid, sulfuric acid, nitric acid, phosphoric acid, and boric acid; phosphoric acid esters; carboxylic acids such as acetic acid, formic acid, and trifluoroacetic acid; sulfonic acids such as methanesulfonic acid, trifluoromethanesulfonic acid, and p-toluenesulfonic acid; solid acids such as activated clay; Lewis acids such as iron chloride, and the like.

Examples of the alkali catalyst include alkali metal hydroxides such as lithium hydroxide, sodium hydroxide, potassium hydroxide, and cesium hydroxide; alkali earth metal hydroxides such as magnesium hydroxide, calcium hydroxide, and barium hydroxide; alkali metal carbonate such as lithium carbonate, sodium carbonate, potassium carbonate, and cesium carbonate; alkali earth metal carbonates such as magnesium carbonate; alkali metal hydrogen carbonates such as lithium hydrogen carbonate, sodium hydrogen carbonate, potassium hydrogen carbonate, and cesium hydrogen carbonate; alkali metal organic acid salts (for example, acetate) such as lithium acetate, sodium acetate, potassium acetate, and cesium acetate; alkali earth metal organic acid salts (for example, acetate) such as magnesium acetate; alkali metal alkoxides such as lithium methoxide, sodium methoxide, sodium ethoxide, sodium isopropoxide, potassium ethoxide, and potassium t-butoxide; alkali metal phenoxides such as sodium phenoxide; amines (tertiary amines and the like) such as triethylamine, N-methylpiperidine, 1,8-diazabicyclo[5.4.0]undec-7-ene, and 1,5-diazabicyclo[4.3.0]non-5-ene; nitrogen-containing aromatic heterocyclic compounds such as pyridine, 2,2′-bipyridyl, and 1,10-phenanthroline, and the like.

One kind of catalyst can be used singly, or two or more kinds of catalysts can be used in combination. Furthermore, the catalyst can be used in a state of being dissolved or dispersed in water, an organic solvent, or the like.

The catalyst is preferably a base catalyst. In a case where a base catalyst is used, the condensation rate of the polyorganosilsesquioxane can be increased, and an excellent deformation recovery rate can be maintained after curing.

The amount of the catalyst used is not particularly limited, and can be appropriately adjusted within a range of 0.002 to 0.200 mol with respect to the total amount (1 mol) of the hydrolyzable silane compounds.

The amount of water used in the above hydrolysis and condensation reactions is not particularly limited, and can be appropriately adjusted within a range of 0.5 to 20 mol with respect to the total amount (1 mol) of the hydrolyzable silane compounds.

The method of adding water is not particularly limited. The entirety of water to be used (total amount of water to be used) may be added at once or added sequentially. In a case where water is added sequentially, the water may be added continuously or intermittently.

As the reaction conditions for performing the hydrolysis and condensation reactions of the hydrolyzable silane compounds, it is particularly important to select reaction conditions so that the condensation rate of the polyorganosilsesquioxane (a1) is equal to or higher than 80%. The reaction temperature of the hydrolysis and condensation reactions is, for example, 40° C. to 100° C. and preferably 45° C. to 80° C. In a case where the reaction temperature is controlled within the above range, the condensation rate tends to be controlled and become equal to or higher than 80%. The reaction time of the hydrolysis and condensation reactions is, for example, 0.1 to 10 hours and preferably 1.5 to 8 hours. Furthermore, the hydrolysis and condensation reactions can be carried out under normal pressure or under pressure that is increased or reduced. The hydrolysis and condensation reactions may be performed, for example, in any of a nitrogen atmosphere, an inert gas atmosphere such as argon gas atmosphere, or an aerobic atmosphere such as an air atmosphere. Among these, the inert gas atmosphere is preferable.

By the hydrolysis and condensation reactions of the hydrolyzable silane compounds described above, the polyorganosilsesquioxane (a1) is obtained. After the hydrolysis and condensation reactions are finished, it is preferable to neutralize the catalyst so as to inhibit the ring opening of the epoxy group. In addition, the polyorganosilsesquioxane (a1) may be separated and purified by a separation method such as rinsing, acid cleaning, alkali cleaning, filtration, concentration, distillation, extraction, crystallization, recrystallization, or column chromatography, or by a separation method using these in combination.

In the hardcoat layer of the hardcoat film according to the embodiment of the present invention, from the viewpoint of hardness of the film, the condensation rate of the polyorganosilsesquioxane (a1) is preferably equal to or higher than 80%. The condensation rate is more preferably equal to or higher than 90%, and more preferably equal to or higher than 95%.

In a case where the ²⁹Si nuclear magnetic resonance (NMR) spectrum is measured for a hardcoat film sample having the hardcoat layer containing the cured product of the polyorganosilsesquioxane (a1), the condensation rate can be calculated using the measurement result.

In the cured product of the polyorganosilsesquioxane (a1) having an epoxy group, it is preferable that the epoxy group undergo ring opening by a polymerization reaction.

In the hardcoat layer of the hardcoat film according to the embodiment of the present invention, from the viewpoint of hardness of the film, the ring opening rate of the epoxy group in the cured product of the polyorganosilsesquioxane (a1) is preferably equal to or higher than 40%. The ring opening rate is more preferably equal to or higher than 50%, and even more preferably equal to or higher than 60%.

The ring opening rate can be obtained by analyzing a composition for forming a hardcoat layer containing polyorganosilsesquioxane (a1) by means of Fourier transform infrared spectroscopy (FT-IR) single reflection attenuated total reflection (ATR) before and after the sample is totally cured and treated with heat. From the change in the height of a peak resulting from the epoxy group, the ring opening rate can be calculated.

One kind of polyorganosilsesquioxane (a1) may be used singly, or two or more kinds of polyorganosilsesquioxanes (a1) having different structures may be used in combination.

(Polyorganosilsesquioxane (a2) Having (meth)acryloyl group)

The polyorganosilsesquioxane (a2) having a (meth)acryloyl group (also called “polyorganosilsesquioxane (a2)”) is preferably a polyorganosilsesquioxane which has at least a siloxane constitutional unit containing a (meth)acryloyl group and is represented by General Formula (2).

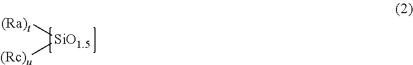

In General Formula (2), Ra represents a group containing a (meth)acryloyl group, and Rc represents a monovalent substituent. t and u each represent a proportion of each of Ra and Rc in General Formula (2), t+u=100, t is greater than 0, and u is equal to or greater than 0. In a case where there is a plurality of Ra's and Rc's in General Formula (2), the plurality of Ra's and Rc's may be the same as or different from each other respectively. In a case where there is a plurality of Rc's in General Formula (2), the plurality of Rc's may form a bond with each other.

In General Formula (2), Ra represents a group containing a (meth)acryloyl group.

Examples of the group containing a (meth)acryloyl group include known groups having a (meth)acryloyl group.

Ra is preferably a group represented by General Formula (1a).

*—R^{11a}—OCO—CR^{12a}═CH₂ (1a)

In General Formula (1a), * represents a portion linked to Si in General Formula (2), R^{11a} represents a substituted or unsubstituted alkylene group or a substituted or unsubstituted phenylene group, and R^{12a} represents hydrogen atom or a substituted or unsubstituted alkyl group.

R^{11a} represents a substituted or unsubstituted alkylene group or a substituted or unsubstituted phenylene group.

Examples of the substituted or unsubstituted alkylene group represented by R^{11a} include a substituted or unsubstituted alkylene group having 1 to 10 carbon atoms.

Examples of the alkylene group having 1 to 10 carbon atoms include a methylene group, an ethylene group, a propylene group, an isopropylene group, a n-butylene group, an isobutylene group, a s-butylene group, a t-butylene group, a n-pentylene group, an isopentylene group, a s-pentylene group, a t-pentylene group, a n-hexylene group, an isohexylene group, a s-hexylene group, a t-hexylene group, and the like.

In a case where the alkylene group has a substituent, examples of the substituent include a hydroxyl group, a carboxyl group, an alkoxy group, an aryl group, a heteroaryl group, a halogen atom, a nitro group, a cyano group, a silyl group, and the like.

In a case where the phenylene group represented by R^{11a} has a substituent, examples of the substituent include a hydroxyl group, a carboxyl group, an alkoxy group, an alkyl group, a halogen atom, and the like.

R^{11a} is preferably an unsubstituted linear alkylene group having 1 to 3 carbon atoms, and more preferably a propylene group.

R^{12a} represents a hydrogen atom or a substituted or unsubstituted alkyl group.

Examples of the substituted or unsubstituted alkyl group represented by R^{12a} include a substituted or unsubstituted alkyl group having 1 to 3 carbon atoms.

In a case where the alkyl group has a substituent, examples of the substituent include a hydroxyl group, a carboxyl group, an alkoxy group, an aryl group, a heteroaryl group, a halogen atom, a nitro group, a cyano group, a silyl group, and the like.

R^{12a} is preferably a hydrogen atom or a methyl group, and more preferably a hydrogen atom.

It is also preferable that Ra is a group containing a plurality of (meth)acryloyl groups. For example, Ra is preferably a group represented by General Formula (2a).

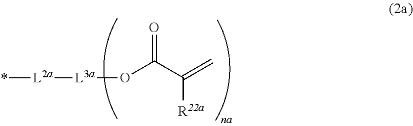

In General Formula (2a), * represents a portion linked to Si in General Formula (2), L^{2a} represents a single bond or a divalent linking group, R^{22a} represents a hydrogen atom or a substituted or unsubstituted alkyl group, L^{3a} represents an (na+1)-valent linking group, and na represents an integer equal to or greater than 2.

Examples of the divalent linking group represented by L^{2a} include a substituted or unsubstituted alkylene group (preferably having 1 to 10 carbon atoms), —O—, —CO—, —COO—, —S—, —NH—, and a divalent linking group obtained by combining these.

Examples of the substituted or unsubstituted alkylene group include the substituted or unsubstituted alkylene group represented by R^{11a} in General Formula (1a).

L^{2a} is preferably a group in which two adjacent carbon atoms in a substituted or unsubstituted alkylene group having 1 to 10 carbon atoms are bonded to each other through at least one bond selected from —O—, —CO—, —COO—, —S—, or —NH—.

R^{22a} has the same definition as R^{12a} in General Formula (1a), and preferred examples thereof are also the same.

na is preferably an integer of 2 to 4, and more preferably 2 or 3.

L^{3a} represents an (na+1)-valent linking group, and preferably represents an (na+1)-valent hydrocarbon group. In a case where L^{3a} represents an (na+1)-valent hydrocarbon group, the hydrocarbon group may further have a substituent (for example, a hydroxyl group, a carboxyl group, an alkoxy group, an aryl group, or a halogen atom), or may have a hetero atom (for example, an oxygen atom, a sulfur atom, or a nitrogen atom) in a hydrocarbon chain.

Ra in General Formula (2) is derived from a group (a group other than an alkoxy group and a halogen atom; for example, Ra in a hydrolyzable silane compound represented by Formula (A) which will be described later, or the like) bonded to a silicon atom in the hydrolyzable trifunctional silane compound used as a raw material of the polyorganosilsesquioxane.

Specific examples of Ra are as below, but the present invention is not limited thereto. In the following specific examples, * represents a portion linked to Si in General Formula (2).

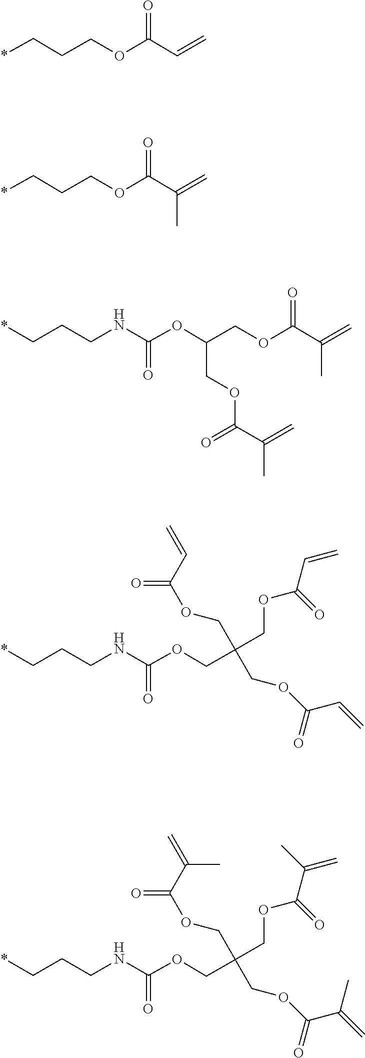

In General Formula (2), Rc represents a monovalent group.

The monovalent group represented by Rc in General Formula (2) has the same definition as Rc in General Formula (1), and preferred examples thereof are also the same. However, it is preferable that the monovalent group represented by Rc in General Formula (2) do not have a perfluoropolyether group.

In a case where there is a plurality of Rc's in General Formula (2), the plurality of Rc's may form a bond with each other. The number of Rc's forming a bond with each other is preferably 2 or 3, and more preferably 2.

The group (Rc₂) formed by the bonding of two Rc's in General Formula (2) and the group (Rc₃) formed by the bonding of three Rc's in General Formula (2) have the same definitions as the group (Rc₂) formed by the bonding of two Rc's in General Formula (1) and the group (Rc₃) formed by the bonding of three Rc's in General Formula (1), and the groups preferable as these are also the same.

Rc in General Formula (2) is derived from a group (a group other than an alkoxy group and a halogen atom; for example, Rc₁ to Rc₃ in a hydrolyzable silane compound represented by Formulas (C1) to (C3) described above, or the like) bonded to a silicon atom in the hydrolyzable silane compound used as a raw material of the polyorganosilsesquioxane.

In General Formula (2), t is greater than 0, and u is equal to or greater than 0.

t/(t+u) is preferably 0.5 to 1.0. In a case where the amount of groups represented by Ra is half or more of the total amount of groups represented by Ra or Rc contained in the polyorganosilsesquioxane (a2), crosslinks are sufficiently formed between the polyorganosilsesquioxane molecules. Therefore, excellent scratch resistance can be maintained.

t/(t+u) is more preferably 0.7 to 1.0, even more preferably 0.9 to 1.0, and particularly preferably 0.95 to 1.0.

It is also preferable that there be a plurality of Rc's in General Formula (2), and the plurality of Rc's form a bond with each other. In this case, u/(t+u) is preferably 0.00 to 0.20.

u/(t+u) is more preferably 0.00 to 0.10, even more preferably 0.00 to 0.05, and particularly preferably 0.00 to 0.025.

The number-average molecular weight (Mn) of the polyorganosilsesquioxane (a2) that is measured by gel permeation chromatography (GPC) and expressed in terms of standard polystyrene is preferably 500 to 6,000, more preferably 1,000 to 4,500, and even more preferably 1,500 to 3,000.

The molecular weight dispersity (Mw/Mn) of the polyorganosilsesquioxane (a2) that is measured by GPC and expressed in terms of standard polystyrene is, for example, 1.0 to 4.0, preferably 1.1 to 3.7, more preferably 1.1 to 3.0, and even more preferably 1.1 to 2.5. Mn represents a number-average molecular weight.

The weight-average molecular weight and the molecular weight dispersity of the polyorganosilsesquioxane (a2) are measured by the same method as that used for the polyorganosilsesquioxane (a1).

<Method for Manufacturing Polyorganosilsesquioxane (a2)>

The polyorganosilsesquioxane (a2) can be manufactured by a known manufacturing method and is not particularly limited. The polyorganosilsesquioxane (a2) can be manufactured preferably by a method of hydrolyzing and condensing one kind of hydrolyzable silane compound or two or more kinds of hydrolyzable silane compounds. As the hydrolyzable silane compound, it is preferable to use a hydrolyzable trifunctional silane compound (a compound represented by Formula (A)) for forming a siloxane constitutional unit containing a (meth)acryloyl group).

In a case where u in General Formula (2) is greater than 0, as the hydrolyzable silane compounds, it is preferable to use the compounds represented by Formula (C1), (C2), or (C3) in combination.

Ra−Si(X¹)₃ (A)

Ra in Formula (A) has the same definition as Ra in General Formula (2), and preferred examples thereof are also the same.

X¹ in Formula (A) represents an alkoxy group or a halogen atom.

Examples of the alkoxy group represented by X¹ include an alkoxy group having 1 to 4 carbon atoms such as a methoxy group, an ethoxy group, a propoxy group, an isopropyloxy group, a butoxy group, and an isobutyloxy group.

Examples of the halogen atom represented by X¹ include a fluorine atom, a chlorine atom, a bromine atom, an iodine atom, and the like.

As X¹, an alkoxy group is preferable, and a methoxy group and an ethoxy group are more preferable. Three X¹'s may be the same as or different from each other.

The compound represented by Formula (A) is a compound forming a siloxane constitutional unit having Ra.

As the hydrolyzable silane compound, hydrolyzable silane compounds other than the compounds represented by Formulas (A) and (C1) to (C3) may be used in combination. Examples thereof include a hydrolyzable trifunctional silane compound, a hydrolyzable monofunctional silane compound, a hydrolyzable difunctional silane compound, a hydrolyzable tetrafunctional silane compound, and the like other than the compounds represented by Formulas (A) and (C1) to (C3). Specific examples thereof include tetraalkoxysilane, dialkoxysilane, and monoalkoxysilane.

In a case where Rc is derived from Rc₁ to Rc₃ in the hydrolyzable silane compounds represented by Formulas (C1) to (C3), in order to adjust t/(t+u) in General Formula (2), a mixing ratio (molar ratio) among the compounds represented by Formulas (A) and (C1) to (C3) may be adjusted.

Specifically, for example, in order to adjust t/(t+u) to 0.5 to 1.0, a value represented by the following (Z3) may be set to 0.5 to 1.0, and a method of hydrolyzing and condensing these compounds may be used to manufacture the polyorganosilsesquioxane (c1).

(Z3)={compound represented by Formula (A) (molar amount)}/{compound represented by Formula (A) (molar amount)+compound represented by Formula (C1) (molar amount)+compound represented by Formula (C2) (molar amount)×2+compound represented by Formula (C3) (molar amount)×3}

The amount of the above hydrolyzable silane compounds used and the composition thereof can be appropriately adjusted depending on the desired structure of the polyorganosilsesquioxane (a2).

In the polyorganosilsesquioxane (a2), the content of components derived from the compound represented by Formula (A) is preferably equal to or greater than 70 mol % and equal to or smaller than 100 mol %, and more preferably equal to or greater than 75 mol % and equal to or smaller than 100 mol %. In a case where the content of components derived from the compound represented by Formula (A) is equal to or greater than 70 mol %, excellent pencil hardness can be maintained due to a sufficient recovery rate, and sufficient scratch resistance can be secured.

The hydrolysis and condensation reactions of the hydrolyzable silane compounds can be performed in the same manner as the hydrolysis and condensation reactions of the hydrolyzable silane compounds in the method for manufacturing the polyorganosilsesquioxane (a1) described above.

By the hydrolysis and condensation reactions of the hydrolyzable silane compounds described above, the polyorganosilsesquioxane (a2) is obtained. After the hydrolysis and condensation reactions are finished, it is preferable to neutralize the catalyst so as to inhibit the polymerization of the (meth)acryloyl group. In addition, the polyorganosilsesquioxane (a2) may be separated and purified by a separation method such as rinsing, acid cleaning, alkali cleaning, filtration, concentration, distillation, extraction, crystallization, recrystallization, or column chromatography, or by a separation method using these in combination.

One kind of polyorganosilsesquioxane (a2) may be used singly, or two or more kinds of polyorganosilsesquioxanes (a2) having different structures may be used in combination.

From the viewpoint of the hardness of the film, the condensation rate of the polyorganosilsesquioxane (a2) is preferably equal to or higher than 50%. The condensation rate is more preferably equal to or higher than 80%, and even more preferably equal to or higher than 90%.

The condensation rate can be calculated using the results obtained by measuring a ²⁹Si nuclear magnetic resonance (NMR) spectrum of the polyorganosilsesquioxane (a2) not yet being cured. In the ²⁹Si NMR spectrum, silicon atoms show signals (peaks) at different positions (chemical shifts) depending on the bonding state of the silicon atoms. Therefore, by performing assignment of the signals and calculating the integration ratio, the condensation rate can be calculated.

In the present invention, the hardcoat layer is preferably formed of a composition for forming a hardcoat layer. In the composition for forming a hardcoat layer, the content rate of a polyorganosilsesquioxane (preferably the polyorganosilsesquioxane (A) having a polymerizable group) with respect to the total solid content of the composition for forming a hardcoat layer is preferably equal to or higher than 50% by mass and equal to or lower than 100% by mass, more preferably equal to or higher than 70% by mass and equal to or lower than 100% by mass, and even more preferably equal to or higher than 80% by mass and equal to or lower than 100% by mass. The total solid content means all components other than solvents.

(Compound Having Polyrotaxane Structure)

It is preferable that the hardcoat layer contain a compound having a polyrotaxane structure.

“Compound having a polyrotaxane structure” may be a polyrotaxane or a compound composed of two or more polyrotaxanes bonded together (for example, a cured product of a polyrotaxane having a polymerizable group). The cured product of a polyrotaxane having a polymerizable group is preferably obtained by curing a composition containing a polyrotaxane having a polymerizable group by at least either heating or irradiation with ionizing radiation. The cured product of a polyrotaxane having a polymerizable group may be a cured product of a composition containing the aforementioned polyorganosilsesquioxane (A) having a polymerizable group and a polyrotaxane having a polymerizable group.

(Polyrotaxane)

A polyrotaxane is composed of cyclic molecules and a linear molecule passing through opening portions of the cyclic molecules just as a skewer, in which blocking groups are arranged at both terminals of a pesudo-polyrotaxane (both terminals of the linear molecule) composed of the plurality of cyclic molecules and the linear molecule included in the cyclic molecules so that the cyclic molecules do not fall off.

From the viewpoint of increasing pencil hardness, the weight-average molecular weight of the polyrotaxane is preferably equal to or lower than 1,000,000. The weight-average molecular weight of the polyrotaxane is more preferably equal to or lower than 600,000, and particularly preferably 600,000 to 180,000.

(Linear Molecule)

The linear molecule contained in the polyrotaxane is not particularly limited as long as it is a linear molecule or substance which is included in the cyclic molecules and can non-covalently unify the cyclic molecules. In the present invention, “linear molecule” refers to molecules including polymers and all other substances satisfying the above requirements.

Furthermore, in the present invention, “linear” of “linear molecule” means that the molecule is substantially “straight chain”. That is, as long as the cyclic molecules as a rotor can rotate or can slide or move on the linear molecule, the linear molecule may have a branched chain. Furthermore, the length of “straight chain” is not particularly limited as long as the cyclic molecules can slide or move on the linear molecule.

Examples of the linear molecule of the polyrotaxane include hydrophilic polymers, for example, polyvinyl alcohol, polyvinylpyrrolidone, poly(meth)acrylic acid, cellulose-based resins (such as carboxymethyl cellulose, hydroxyethyl cellulose, and hydroxypropyl cellulose), polyacrylamide, polyethylene oxide, polyethylene glycol, polyvinyl acetal-based resins, polyvinyl methyl ether, polyamine, polyethyleneimine, casein, gelatin, starch and/or copolymers of these; hydrophobic polymers, for example, polyolefin-based resins such as polyethylene, polypropylene, and copolymer resins with other olefin-based monomers, polyester resins, polyvinyl chloride resins, polystyrene-based resins such as polystyrene and acrylonitrile-styrene copolymer resins, acrylic resins such as polymethyl methacrylate or (meth)acrylic acid ester copolymers and acrylonitrile-methyl acrylate copolymer resins, polycarbonate resins, polyurethane resins, vinyl chloride-vinyl acetate copolymer resins, and polyvinyl butyral resins; and derivatives or modified products of these.

Among the hydrophilic polymers, polyethylene glycol, polypropylene glycol, a copolymer of polyethylene glycol and polypropylene glycol, polyisoprene, polyisobutylene, polybutadiene, polytetrahydrofuran, polydimethylsiloxane, polyethylene, and polypropylene are preferable. Among these, polyethylene glycol, polyethylene glycol, and a copolymer of polyethylene glycol and polypropylene glycol are more preferable, and polyethylene glycol is particularly preferable.

It is preferable that the linear molecule of the polyrotaxane have a high breaking strength. The breaking strength of the hardcoat film depends on other factors such as the bonding strength between the blocking group and the linear molecule, the bonding strength between the cyclic molecule and the binder of the hardcoat layer, and the bonding strength between the cyclic molecules. However, in a case where the linear molecule of the polyrotaxane has a high breaking strength, the breaking strength of the hardcoat film can be further improved.

The molecular weight of the linear molecule of the polyrotaxane is equal to or higher than 1,000, for example, 1,000 to 1,000,000. The molecular weight is preferably equal to or higher than 5,000, for example, 5,000 to 1,000,000 or 5,000 to 500,000. The molecular weight is more preferably equal to or higher than 10,000, for example 10,000 to 1,000,000, 10,000 to 500,000, or 10,000 to 300,000.

Furthermore, in view of “eco-friendliness”, it is preferable that the linear molecule of the polyrotaxane be a biodegradable molecule.

It is preferable that the linear molecule of the polyrotaxane have a reactive group at both terminals thereof. In a case where the linear molecule has the reactive group, the blocking group can easily react with the reactive group. The reactive group depends on the blocking group used. Examples of the reactive group include a hydroxyl group, an amino group, a carboxyl group, a thiol group, and the like.

(Cyclic Molecule)

As the cyclic molecules of the polyrotaxane, any cyclic molecule can be used as long as it can include the linear molecule.

In the present invention, “cyclic molecule” refers to various cyclic substances including cyclic molecules. Furthermore, in the present invention, “cyclic molecule” refers to a molecule or substance that is substantially circular. That is, “substantially circular” means that the cyclic molecule also includes molecules that are in the form of an incomplete ring just as the letter “C” having a helical structure in which one end and the other end of “C” overlap each other without being connected. The definition of “substantially circular” for “cyclic molecule” can also be applied to the rings relating to “bicyclic molecule” which will be described later. That is, either or both of the rings of “bicyclic molecule” may be an incomplete ring just as the letter “C” or may have a helical structure in which one end and the other end of the letter “C” overlap each other without being connected.

Examples of the cyclic molecules of the polyrotaxane include various cyclodextrins (for example, α-cyclodextrin, β-cyclodextrin, γ-cyclodextrin, dimethyl cyclodextrin, glucosyl cyclodextrin, derivatives or modified products of these, and the like), crown ethers, benzocrowns, dibenzocrowns, dicyclohexanocrowns, and derivatives or modified products of these.

The size of the opening portion of the aforementioned cyclodextrins, crown ethers, and the like varies according to the type of cyclic molecules. Therefore, in a case where a certain type of linear molecule, specifically, a cylindrical linear molecule is to be used, the cyclic molecules to be used can be selected according to the diameter of a cross section of the cylinder, the hydrophobicity or hydrophilicity of the linear molecule, and the like. Furthermore, in a case where cyclic molecules having a relatively large opening portion and a cylindrical linear molecule having a relatively small diameter are used, two or more such linear molecules can be included in the opening portion of the cyclic molecules. Among the aforementioned cyclic molecules, in view of “eco-friendliness” described above, cyclodextrins are preferable because these are biodgradable.

As cyclic molecules, it is preferable to use α-cyclodextrin.

In a case where cyclodextrin is used as cyclic molecules, and the maximum number (maximum inclusion amount) of cyclic molecules that will include a linear molecule is 1, the inclusion amount of the cyclodextrin is preferably 0.05 to 0.60, more preferably 0.10 to 0.50, and even more preferably 0.20 to 0.40. In a case where the inclusion amount is less than 0.05, sometimes a pulley effect is not exhibited. In a case where the inclusion amount is higher than 0.60, the cyclic molecules, cyclodextrin, are excessively densely arranged, which sometimes leads to the decrease in the mobility of the cyclodextrin. In addition, the solubility of the cyclodextrin in an organic solvent decreases further, and sometimes the solubility of the obtained polyrotaxane in an organic solvent also decreases.

It is preferable that each of the cyclic molecules of the polyrotaxane have a reactive group on the outside of the ring. In bonding or crosslinking the cyclic molecules, the reaction can be easily carried out using this reactive group. The reactive group depends on the crosslinking agent used and the like. Examples of the reactive group include a hydroxyl group, an amino group, a carboxyl group, a thiol group, an aldehyde group, and the like. In addition, in performing the blocking reaction described above, it is preferable to use a group that does not react with the blocking group.

(Polyrotaxane Having Polymerizable Group)

The compound having a polyrotaxane structure is preferably a cured product of a polyrotaxane having a polymerizable group.

The polymerizable group in the polyrotaxane having a polymerizable group is not particularly limited, but is preferably a radically or cationically polymerizable group.

As the radically polymerizable group, a generally known radically polymerizable group can be used. For example, a vinyl group and a (meth)acryloyl group are suitable as the radically polymerizable group. Particularly, a (meth)acryloyl group is preferable.

As the cationically polymerizable group, a generally known cationically polymerizable group can be used. Specifically, examples thereof include an alicyclic ether group, a cyclic acetal group, a cyclic lactone group, a cyclic thioether group, a spiro-orthoester group, a vinyloxy group, and the like. Among these, an alicyclic ether group and a vinyloxy group are suitable, an epoxy group, an oxetanyl group, and a vinyloxy group are particularly preferable, and an epoxy group is mostly preferably used.

The compound having a polyrotaxane structure is preferably a cured product of a polyrotaxane having at least one of a (meth)acryloyl group or an epoxy group.

The polyrotaxane preferably has an unsaturated bond group in view of pencil hardness, and more preferably has an unsaturated double bond group.

The position of an unsaturated bond group in the polyrotaxane is not particularly limited. For example, the unsaturated bond group can be introduced into a portion corresponding to the cyclic molecules. The introduction of this group enables polymerization with a monomer having an ethylenically unsaturated group.

The introduction of an unsaturated bond group can be performed, for example, by substituting at least some of the cyclic molecules having a hydroxyl group (—OH), such as cyclodextrin, with an unsaturated bond group which is preferably an unsaturated double bond group.

Examples of the unsaturated bond group such as an unsaturated double bond group include an olefinyl group. Examples of the olefinyl group include, but are not limited to, an acryloyl group, a methacryloyl group, a vinyl ether group, a styryl group, and the like. From the viewpoint of increasing pencil hardness, the unsaturated double bond group is preferably a methacryloyl group.

For example, the following methods can be used for the introduction of an unsaturated double bond group. That is, examples of the methods include a method of forming a carbamate bond by an isocyanate compound or the like; a method of forming an ester bond by a carboxylic acid compound, an acid chloride compound, an acid anhydride, or the like; a method of forming a silyl ether bond by a silane compound or the like; a method of forming a carbonate bond by a chlorocarbonate compound, and the like.

In a case where a (meth)acryloyl group is introduced as an unsaturated double bond group via a carbamoyl bond, the polyrotaxane is dissolved in a dehydrating solvent such as dimethyl sulfoxide or dimethylformamide, and a (meth)acryloylating agent having an isocyanate group is added thereto. Furthermore, in a case where a (meth)acryloyl group is introduced via an ether bond or an ester bond, a (meth)acrylating agent having an active group, such as a glycidyl group or an acid chloride, can also be used.

The step of substituting the hydroxyl groups of the cyclic molecules with an unsaturated double bond group may be performed before, during, or after a step of preparing a pseudo-polyrotaxane. In addition, the step of substituting the hydroxyl groups may be performed before, during, or after a step of preparing a polyrotaxane by blocking the pseudo-polyrotaxane. Furthermore, in a case where the polyrotaxane is a crosslinked polyrotaxane, the step of substituting the hydroxyl groups may be performed before, during, or after a step of crosslinking polyrotaxanes. The step of substituting the hydroxyl groups may be performed at two or more timings among the above. The substitution step is preferably performed at the timing that follows the step of preparing a polyrotaxane by blocking the pseudo-polyrotaxane and precedes the step of crosslinking polyrotaxanes. The conditions used in the substitution step depend on the unsaturated double bond group as a substituent, and are not particularly limited. Various reaction methods and reaction conditions can be used.

(Blocking Group)

As the blocking group of the polyrotaxane, any group may be used as long as the cyclic molecules remain threaded onto the linear molecule. Examples of such a group include a group having “bulkiness” and/or a group having “ionicity”. “Group” means various groups including a molecular group and a polymer group. In addition, by the interaction, such as repulsion, between “ionicity” of the group having “ionicity” and “ionicity” of the cyclic molecules, the cyclic molecules can remain threaded onto the linear molecule.

As described above, the blocking group of the polyrotaxane may be the main chain or side chain of a polymer as long as the blocking group keeps the cyclic molecules being threaded onto the linear molecule.

Specifically, examples of the blocking group as a molecular group include dinitrophenyl groups such as a 2,4-dinitrophenyl group and a 3,5-dinitrophenyl group, cyclodextrins, adamantane groups, trityl groups, fluoresceins, pyrenes, and derivatives or modified products of these. More specifically, in a case where α-cyclodextrin is used as cyclic molecules and polyethylene glycol is used as a linear molecule, examples of the blocking group include cyclodextrins, dinitrophenyl groups such as a 2,4-dinitrophenyl group and a 3,5-dinitrophenyl group, adamantane groups, trityl groups, fluoresceins, pyrenes, and derivatives or modified products of these.

Next, a modified polyrotaxane that can be preferably used in the present invention will be described. In the present invention, a polyrotaxane designed using a plurality of the following modification methods in combination can be preferably used.

(Crosslinked Polyrotaxane)

A crosslinked polyrotaxane refers to a compound composed of two or more polyrotaxanes in which a chemical bond is formed between cyclic molecules thereof. The cyclic molecules of the two polyrotaxanes may be the same as or different from each other. The chemical bond may be simply a bond or a bond formed via various atoms or molecules.

Furthermore, as cyclic molecules, it is possible to use molecules having a crosslinked ring structure, that is, “bicyclic molecules” each having a first ring and a second ring. In this case, for example, by mixing “bicyclic molecules” with a linear molecule, it is possible to obtain a crosslinked polyrotaxane in which the first ring and the second ring include and are threaded onto the linear molecule.

In this crosslinked polyrotaxane, the cyclic molecules threaded onto the linear molecule in the form of a skewer can move along the linear molecule (pulley effect). Therefore, the polyrotaxane has viscoelasticity, and even though tension is applied thereto, the tension is uniformly dispersed due to the pulley effect, and the internal stress is relieved.

(Hydrophobically Modified Polyrotaxane)

In a case where cyclodextrins, such as α-cyclodextrin, are used as cyclic molecules of a polyrotaxane, in the present invention, a hydrophobically modified polyrotaxane which is obtained by substituting at least one of the hydroxyl groups of cyclodextrin with another organic group (hydrophobic group) is more preferably used, because such a polyrotaxane exhibits higher solubility in the solvent contained in the composition for forming a hardcoat layer.

Specific examples of the hydrophobic group include an alkyl group, a benzyl group, a benzene derivative-containing group, an acyl group, a silyl group, a trityl group, a nitric acid ester group, a tosyl group, an alkyl-substituted ethylenically unsaturated group as a photocuring moiety, an alkyl-substituted epoxy group as a thermocuring moiety, and the like. However, the hydrophobic group is not limited to these. Furthermore, in the aforementioned hydrophobically modified polyrotaxane, one kind of the above hydrophobic group may be used alone, or two or more kinds of the above hydrophobic groups may be used in combination.

Assuming that the maximum number of modifiable hydroxyl groups of cyclodextrin is 1, a degree of modification by the aforementioned hydrophobic modification group is preferably equal to or higher than 0.02 (equal to or lower than 1), more preferably equal to or higher than 0.04, and even more preferably equal to or higher than 0.06.

In a case where the degree of modification is less than 0.02, the solubility in an organic solvent is not sufficient, and sometimes insoluble matters (protrusion portions resulting from the adhesion of foreign substances and the like) are generated.

The maximum number of modifiable hydroxyl groups of cyclodextrin is in other words the total number of hydroxyl groups that cyclodextrin has before modification. The degree of modification is in other words a ratio of the number of modified hydroxyl groups to the total number of hydroxyl groups.

The number of hydrophobic modification groups may be at least one. In this case, it is preferable that one cyclodextrin ring have one hydrophobic modification group.

Furthermore, by introducing the hydrophobic modification group having a functional group, the reactivity with other polymers can be improved. Next, a polyrotaxane having an unsaturated double bond group will be described. The unsaturated double bond group functions as a hydrophobic modification group.

As commercially available polyrotaxanes, SeRM superpolymers SH3400P, SH2400P, SH1310P, SM3405P, SM1315P, SM1303, SA1303P, SA3405P, SA2405P, SA1315P, SH3400C, SA3400C, and SA2400C manufactured by ASM Inc., and the like can be preferably used.

In a case where the composition for forming a hardcoat layer contains a polyrotaxane, the content of the polyrotaxane (preferably a polyrotaxane having a polymerizable group) in the composition for forming a hardcoat layer with respect to 100 parts by mass of a polyorganosilsesquioxane (preferably the polyorganosilsesquioxane (A) having a polymerizable group) in the composition for forming a hardcoat layer is preferably 1 to 80 parts by mass, and more preferably 5 to 50 parts by mass.

(Compounds (b1) to (b4))

From the viewpoint of folding resistance, it is preferable that the hardcoat layer in the present invention contain a cured product of at least one of a compound (b1) having two or more (meth)acryloyl groups in one molecule (also called “compound (b1)”), a compound (b2) having two or more epoxy groups in one molecule (also called “compound (b2)”), a compound (b3) having two or more oxetanyl groups in one molecule (also called “compound (b3)”), or a blocked isocyanate compound (b4) (also called “compound (b4)”).

The compounds (b1) to (b4) are compounds other than the polyorganosilsesquioxane (A) having a polymerizable group and the polyrotaxane having a polymerizable group described above.

Furthermore, the cured product of at least one of the compounds (b 1) to (b4) may be a cured product of a composition containing the polyorganosilsesquioxane (A) having a polymerizable group and at least one compound among the compounds (b1) to (b4).

The molecular weight of the compounds (b1) to (b4) is preferably equal to or lower than 2,000, and more preferably 100 to 1,000.

(Compound (b1) Having Two or More (meth)acryloyl Groups in One Molecule)

Examples of the compound (b1) include a compound having two (meth)acryloyl groups in one molecule (“difunctional (meth)acrylate) and a compound having three or more (meth)acryloyl groups in one molecule ((meth)acrylate having a valency equal to or higher than 3).

—Difunctional (meth)acrylate—

The difunctional (meth)acrylate is suitable from the viewpoint of reducing the viscosity of the composition. As the difunctional (meth)acrylate, a (meth)acrylate compound having excellent reactivity and causing no problem such as a residual catalyst is preferable.

As the difunctional (meth)acrylate, for example, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, dicyclopentanyl di(meth)acrylate, and the like are suitable.

—(Meth)acrylate Having Valency Equal to or Higher Than 3—

The (meth)acrylate having a valency equal to or higher than 3 is suitable from the viewpoint of mechanical strength. As the (meth)acrylate having a valency equal to or higher than 3, a (meth)acrylate compound having excellent reactivity and causing no problem such as a residual catalyst is preferable.

Specifically, for example, epichlorohydrin (ECH)-modified glycerol tri(meth)acrylate, ethylene oxide (EO)-modified glycerol tri(meth)acrylate, propylene oxide (P0)-modified glycerol tri(meth)acrylate, pentaerythritol triacrylate, pentaerythritol tetraacrylate, EO-modified phosphate triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, dipentaerythritol penta(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxytetra(meth)acrylate, pentaerythritol tetra(meth)acrylate, and the like are suitable.

Among these, EO-modified glycerol tri(meth)acrylate, PO-modified glycerol tri(meth)acrylate, trimethylolpropane tri(meth)acrylate, EO-modified trimethylolpropane tri(meth)acrylate, and PO-modified trimethylolpropane tri(meth)acrylate, dipentaerythritol hexa(meth)acrylate, dipentaerythritol penta(meth)acrylate, pentaerythritol ethoxytetra(meth)acrylate, and pentaerythritol tetra(meth)acrylate are suitably used in the present invention.

The composition for forming a hardcoat layer can contain solvents as volatile components, and the solvents can be removed after the formation of a film. Therefore, in this composition, even a high functional radically polymerizable compound which is unusable or used in a limited amount in a composition subjected to coating or curing without a solvent due to the problems such as the solubility during the preparation of the composition or the viscosity during the coating can be suitably used by appropriately adjusting the solubility during the preparation of the composition or the viscosity during the coating by using the solvents.

Examples of the high functional radically polymerizable compound include a (meth)acrylate compound having a structure capable of exhibiting high aggregating properties by hydrogen bonding, such as an isocyanuric group, a urethane group, a urea group, an amide group, an imide group, and a hydroxyl group.

Examples of the (meth)acrylate compounds having an isocyanuric group include (the following are trade names) A-9300 (tris(2-acryloxyethyl)isocyanurate) and A9300-1CL (ε-caprolactone-modified tris-2-acryloxyethyl)isocyanurate manufactured by SHIN-NAKAMURA CHEMICAL CO., LTD. and ARONIX M-313 and M-315 (isocyanuric acid EO-modified di and triacrylate) manufactured by TOAGOSEI CO., LTD.

As the (meth)acrylate compound having a urethane group, it is possible to use a compound obtained by introducing a hydroxyl group to the terminal of a reaction product of an isocyanate having a valency equal to or higher than 2 and an alcohol having a valency equal to or higher than 2, and modifying the terminal with a (meth)acryloyl group. As the isocyanate having a valency equal to or higher than 2, it is possible to use toluene diisocyanate, xylylene diisocyanate, diphenylmethane diisocyanate, hexamethylene diisocyanate, isophorone diisocyanate, tetramethylxylylene diisocyanate, hydrogenated diphenylmethane diisocyanate, and the like. As the alcohol having a valency equal to or higher than 2, it is possible to use alkylene glycol having 2 to 30 carbon atoms, and polyalkylene glycol having a repeating structure of alkylene glycol having 2 to 30 carbon atoms, bisphenol A, an ethylene oxide adduct or propylene oxide adduct of bisphenol A, hydroxyl group-terminated polyester polyols, polyols having a valency equal to or higher than 3, such as glycerol, trimethylolpropane, pentaerythritol, and dipentaerythritol, an ethylene oxide or propylene oxide adduct thereof, and the like. Some of these compounds are commercially available, and examples thereof include (the followings are trade names) U-2PPA, U-6LPA, U-10HA, U-10PA, UA-1100H, and U-15HA, UA-53H, UA-33H, U-200PA, UA-160TM, UA-290TM, UA-4200, UA-4400, and UA-122P manufactured by SHIN-NAKAMURA CHEMICAL CO., LTD., ARONIX M-1100 and M-1200 manufactured by TOAGOSEI CO., LTD., and AH-600, UA-306H, UA-306T, UA-306I, UA-510H, UF-8001G, and DAUA-167 manufactured by KYOEISHA CHEMICAL CO., LTD.

(Compound (b2) Having Two or More Epoxy Groups in One Molecule)

Specific examples of the compound (b2) having two or more epoxy groups in one molecule include an aliphatic epoxy compound and the like.

These are commercially available. Examples thereof include DENACOL EX-611, EX-612, EX-614, EX-614B, EX-622, EX-512, EX-521, EX-411, EX-421, EX-313, EX-314, EX-321, EX-211, EX-212, EX-810, EX-811, EX-830, EX-850, EX-851, EX-821, EX-830, EX-832, EX-841, EX-911, EX-941, EX-920, EX-931, EX-212L, EX-214L, EX-216L, EX-321L, EX-850L, DLC-201, DLC-203, DLC-204, DLC-205, DLC-206, DLC-301, and DLC-402 (manufactured by Nagase ChemteX Corporation.), CELLOXIDE 2021P, 2081, and 3000, EHPE3150, EPOLEAD GT401, and CELVENUS B0134 and B0177 (manufactured by DAICEL CORPORATION.), and the like.

One kind of each of these compounds can be used alone, or two or more kinds of these compounds can be used in combination.

(Compound (b3) Having Two or More Oxetanyl Groups in One Molecule)

Specific examples of the compound (b3) having two or more oxetanyl groups in one molecule include ARON OXETANE OXT-121, OXT-221, OX-SQ, and PNOX (manufactured by TOAGOSEI CO., LTD.).

(Blocked Isocyanate Compound (b4))

The blocked isocyanate compound (b4) is not particularly limited as long as it is a compound having a blocked isocyanate group having a chemically protected isocyanate group. From the viewpoint of curing properties, the compound (b4) is preferably a compound having two or more blocked isocyanate groups in one molecule.

The blocked isocyanate group is a group capable of generating an isocyanate group by heat. As such a group, for example, a group is preferable which has an isocyanate group protected by being reacted with a blocking agent. Furthermore, the blocked isocyanate group is preferably a group capable of generating an isocyanate group by heat of 90° C. to 250° C.

The skeleton of the blocked isocyanate compound is not particularly limited. This compound preferably has two isocyanate groups in one molecule, and may be an aliphatic, alicyclic, or aromatic polyisocyanate. For example, isocyanate compounds, such as 2,4-tolylene diisocyanate, 2,6-tolylene diisocyanate, isophorone diisocyanate, 1,6-hexamethylene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, 2,2′-diethylether diisocyanate, diphenylmethane-4,4′-diisocyanate, o-xylene diisocyanate, m-xylene diisocyanate, p-xylene diisocyanate, methylene bis(cyclohexylisocyanate), cyclohexane-1,3-dimethylene diisocyanate, cyclohexane-1,4-dimethylene diisocyanate, 1,5-naphthalene diisocyanate, p-phenylene diisocyanate, 3,3′-methyleneditolylene-4,4′-diisocyanate, 4,4′-diphenylether diisocyanate, tetrachlorophenylene diisocyanate, norbornane diisocyanate, hydrogenated 1,3-xylylene diisocyanate, and hydrogenated 1,4-xylylene diisocyanate, and compounds having a prepolymer-type skeleton derived from the above compounds can be suitably used. Among these, tolylene diisocyanate (TDI), diphenylmethane diisocyanate (MDI), hexamethylene diisocyanate (HDI), and isophorone diisocyanate (IPDI) are particularly preferable.

Examples of the base structure of the blocked isocyanate compound include a biuret type, an isocyanurate type, an adduct type, and a difunctional prepolymer type, and the like.

Examples of the blocking agent forming the block structure of the blocked isocyanate compound include an oxime compound, a lactam compound, a phenol compound, an alcohol compound, an amine compound, an active methylene compound, a pyrazole compound, a mercaptan compound, an imidazole-based compound, an imide-based compound, and the like. Among these, a blocking agent selected from an oxime compound, a lactam compound, a phenol compound, an alcohol compound, an amine compound, an active methylene compound, and a pyrazole compound is particularly preferable.

The blocked isocyanate compound is available as commercial products. For example, it is possible to preferably use CORONATE AP STABLE M, CORONATE 2503, 2515, 2507, 2513, and 2555 and MILLIONATE MS-50 (manufactured by Nippon Polyurethane Industry Co., Ltd.), TAKENATE B-830, B-815N, B-820NSU, B-842N, B-846N, B-870N, B-874N, and B-882N (manufactured by Mitsui Chemicals, Inc.), DURANATE 17B-60PX, 17B-60P, TPA-B80X, TPA-B80E, MF-B60X, MF-B60B, MF-K60X, MF-K60B, E402-B80B, SBN-70D, SBB-70P, and K6000 (manufactured by Asahi Kasei Corporation.), DESMODUR BL1100, BL1265 MPA/X, BL3575/1, BL3272MPA, BL3370MPA, BL3475BA/SN, BL5375MPA, VPLS2078/2, BL4265SN, PL340, and PL350 and SUMIDUR BL3175 (manufactured by Sumika Bayer Urethane Co., Ltd.), and the like.

In a case where the composition for forming a hardcoat layer contains at least one compound among the aforementioned compounds (b1) to (b4), the total content of the compounds (b1) to (b4) with respect to 100 parts by mass of a polyorganosilsesquioxane (preferably the polyorganosilsesquioxane (A) having a polymerizable group) in the composition for forming a hardcoat layer is preferably 1 to 80 parts by mass, and more preferably 5 to 50 parts by mass.

Furthermore, in a case where the composition for forming a hardcoat layer contains an organic solvent, the total content of the compounds (b1) to (b4) with respect to 100 parts by mass of the organic solvent is preferably 0.05 to 50 parts by mass, and more preferably 1 to 10 parts by mass.

(Other Additives)

The hardcoat layer may contain components other than the above, for example, inorganic particles, a dispersant, a leveling agent, an antifouling agent, an antistatic agent, an ultraviolet absorber, an antioxidant, and the like. These components may be contained in the cured product (matrix) constituting the hardcoat layer.

(Recovery Rate in Indentation Test)

The recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

Because the recovery rate of the hardcoat layer is 84% to 99%, the hardcoat film according to the embodiment of the present invention has excellent pencil hardness. The recovery rate of the hardcoat layer is preferably 85% to 99%.

(Difference in Modulus of Elasticity Between Substrate and Hardcoat Layer)

In a case where σA represents a modulus of elasticity of the substrate of the hardcoat film according to the embodiment of the present invention, and σB represents a modulus of elasticity of the hardcoat layer, a difference (Δσ) of a modulus of elasticity represented by σA−σB is 1,800 to 4,900 MPa. In a case where Δσ is in the above range, high hardness and folding resistance can be simultaneously satisfied. Δσ is preferably 2,500 to 4,900 MPa, more preferably 3,000 to 4,900 MPa, and even more preferably 3,400 to 4,900 MPa.

Δσ can be adjusted depending on the type of polymer used in the substrate, the type and amount of polysilsesquioxane used for forming the hardcoat layer, and the like. Furthermore, Δσ can also be adjusted using a polysilsesquioxane in combination with the aforementioned polyrotaxane and the compounds (b 1) to (b4).

(Film Thickness)

The film thickness of the hardcoat layer is not particularly limited, but is preferably 0.5 to 30 μm, more preferably 1 to 25 μm, and even more preferably 2 to 20 μm. In a case where the film thickness of the hardcoat layer is less than 0.5 μm, sometimes the hardness of the hardcoat film is insufficient. In a case where the film thickness of the hardcoat layer is greater than 30 μm, when the hardcoat film is folded, sometimes the hardcoat layer side is stretched further, and the hardcoat film is easily cracked.

The thickness of the hardcoat layer is calculated by observing the cross section of the hardcoat film by using an optical microscope. The cross-sectional sample can be prepared by a microtome method using a cross section cutting device ultramicrotome, a cross section processing method using a focused ion beam (FIB) device, or the like.

(Anti-Scratch Layer)

The hardcoat film according to the embodiment of the present invention may have an anti-scratch layer on the hardcoat layer.

It is preferable that the anti-scratch layer contain a cured product of at least one of a compound (c1) having two or more (meth)acryloyl groups in one molecule (also called “compound (c1)”) or a compound (c2) having two or more epoxy groups in one molecule (also called “compound (c2)”).

It is preferable that the anti-scratch layer be obtained by curing a composition for forming an anti-scratch layer containing at least one compound between the compounds (c1) and (c2).

The molecular weight of the compounds (c1) and (c2) is not particularly limited. Each of the compounds (c1) and (c2) and may be a monomer, an oligomer, or a polymer.

Specific examples of the compounds (c1) and (c2) include the same compounds as the aforementioned compounds (b1) and (b2).

It is particularly preferable that the anti-scratch layer contain a cured product of a compound having three or more (meth)acryloyl groups in one molecule.

Examples of the compound having three or more (meth)acryloyl groups in one molecule include esters of a polyhydric alcohol and a (meth)acrylic acid. Specifically, examples thereof include pentaerythritol tri(meth)acrylate, pentaerythritol tetra(meth)acrylate, trimethylolpropane tri(meth)acrylate, trimethylolethane tri(meth)acrylate, ditrimethylolpropane tetra(meth)acrylate, dipentaerythritol tetra(meth)acrylate, dipentaerythritol pentaacrylate, dipentaerythritol hexaacrylate, pentaerythritol hexa(meth)acrylate, and the like. In view of a high degree of crosslinking, pentaerythritol triacrylate, pentaerythritol tetraacrylate, or dipentaerythritol pentaacrylate, dipentaerythritol hexaacrylate, or a mixture of these is preferable.

As each of the compounds (c1) and (c2), one kind of compound may be used alone, or two or more kinds of compounds having different structures may be used in combination.

The total content rate of the cured product of the compound (c1) and the cured product of the compound (c2) with respect to the total mass of the anti-scratch layer is preferably equal to or higher than 80% by mass, more preferably equal to or higher than 85% by mass, and even more preferably equal to or higher than 90% by mass.

The total content rate of the compounds (c1) and (c2) in the composition for forming an anti-scratch layer with respect to the total solid content in the composition for forming an anti-scratch layer is preferably equal to or higher than 80% by mass, more preferably equal to or higher than 85% by mass, and even more preferably equal to or higher than 90% by mass.

(Other Additives)

The anti-scratch layer may contain components other than the above, for example, inorganic particles, a leveling agent, an antifouling agent, an antistatic agent, a slip agent, and the like.

Particularly, it is preferable that the anti-scratch layer contain the following fluorine-containing compound as a slip agent.

[Fluorine-Containing Compound]

The fluorine-containing compound may be any of a monomer, an oligomer, or a polymer. It is preferable that the fluorine-containing compound have substituents that contribute to the bond formation or compatibility of the compound with the polyfunctional (meth)acrylate compound (c1) in the anti-scratch layer. These substituents may be the same as or different from each other. It is preferable that the compound have a plurality of such substituents.

The substituents are preferably polymerizable groups, and may be polymerizable reactive groups showing any of radical polymerization properties, polycondensation properties, cationic polymerization properties, anionic polymerization properties, and addition polymerization properties. As the substituents, for example, an acryloyl group, a methacryloyl group, a vinyl group, an allyl group, a cinnamoyl group, an epoxy group, an oxetanyl group, a hydroxyl group, a polyoxyalkylene group, a carboxyl group, an amino group, and the like are preferable. Among these, radically polymerizable groups are preferable, and particularly, an acryloyl group and a methacryloyl group are preferable.

The fluorine-containing compound may be a polymer or an oligomer with a compound having no fluorine atom.

The fluorine-containing compound is preferably a fluorine-based compound represented by General Formula (F).

(R^{f})−[(W)—(R^{A})_{nf}]_{mf} General Formula (F):

(In the formula, R^{f} represents a (per)fluoroalkyl group or a (per)fluoropolyether group, W represents a single bond or a linking group, and R^{A} represents a polymerizable unsaturated group. nf represents an integer of 1 to 3. mf represents an integer of 1 to 3.)

In General Formula (F), R^{A} represents a polymerizable unsaturated group. The polymerizable unsaturated group is preferably a group having an unsaturated bond capable of causing a radical polymerization reaction by being irradiated with active energy rays such as ultraviolet or electron beams (that is, the polymerizable unsaturated group is preferably a radically polymerizable group). Examples thereof include a (meth)acryloyl group, a (meth)acryloyloxy group, a vinyl group, an allyl group, and the like. Among these, a (meth)acryloyl group, a (meth)acryloyloxy group, and groups obtained by substituting any hydrogen atom in these groups with a fluorine atom are preferably used.

In General Formula (F), R^{f} represents a (per)fluoroalkyl group or a (per)fluoropolyether group.

The (per)fluoroalkyl group represents at least one of a fluoroalkyl group or a perfluoroalkyl group, and the (per)fluoropolyether group represents at least one of a fluoropolyether group or a perfluoropolyether group. From the viewpoint of scratch resistance, it is preferable that the fluorine content rate in R^{f} be high.

The (per)fluoroalkyl group is preferably a group having 1 to 20 carbon atoms, and more preferably a group having 1 to 10 carbon atoms.

The (per)fluoroalkyl group may be a linear structure (for example, —CF₂CF₃, —CH₂(CF₂)₄H, —CH₂(CF₂)₈CF₃, —CH₂CH₂(CF₂)₄H), a branched structure (for examples, —CH(CF₃)₂, —CH₂CF(CF₃)₂, —CH(CH₃)CF₂CF₃, —CH(CH₃)(CF₂)₅CF₂H), or an alicyclic structure (preferably a 5- or 6-membered ring, for example, a perfluorocyclohexyl group, a perfluorocyclopentyl group, and an alkyl group substituted with these groups).

The (per)fluoropolyether group refers to a (per)fluoroalkyl group having an ether bond, and may be a monovalent group or a group having a valence of equal to or higher than 2. Examples of the fluoropolyether group include —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H, a fluorocycloalkyl group having 4 to 20 carbon atoms with four or more fluorine atoms, and the like. Examples of the perfluoropolyether group include —(CF₂O)_{pf}—(CF₂CF₂O)_{qf}—, —[CF(CF₃)CF₂O]_{pf}—[CF(CF₃)]_{qf}—, —(CF₂CF₂CF₂O)_{pf}—, —(CF₂CF₂O)_{pf}—, and the like.

pf and qf each independently represent an integer of 0 to 20. Here, pf+qf is an integer equal to or greater than 1.

The sum of pf and qf is preferably 1 to 83, more preferably 1 to 43, and even more preferably 5 to 23.

From the viewpoint of excellent scratch resistance, the fluorine-containing compound particularly preferably has a perfluoropolyether group represented by —(CF₂O)_{pf}—CF₂CF₂O)_{qf}—.

In the present invention, the fluorine-containing compound preferably has a perfluoropolyether group and has a plurality of polymerizable unsaturated groups in one molecule.

In General Formula (F), W represents a linking group. Examples of W include an alkylene group, an arylene group, a heteroalkylene group, and a linking group obtained by combining these groups. These linking groups may further have an oxy group, a carbonyl group, a carbonyloxy group, a carbonylimino group, a sulfonamide group, and a functional group obtained by combining these groups.

W is preferably an ethylene group, and more preferably an ethylene group bonded to a carbonylimino group.

The content of fluorine atoms in the fluorine-containing compound is not particularly limited, but is preferably equal to or greater than 20% by mass, more preferably 30% to 70% by mass, and even more preferably 40% to 70% by mass.

As the fluorine-containing compound, for example, R-2020, M-2020, R-3833, M-3833, and OPTOOL DAC (trade names) manufactured by DAIKIN INDUSTRIES, LTD. and MEGAFACE F-171 F-172, F-179A, RS-78, RS-90, and DEFENSA MCF-300 and MCF-323 (trade names) manufactured by DIC Corporation are preferable, but the fluorine-containing compound is not limited to these.

From the viewpoint of scratch resistance, in General Formula (F), the product of nf and mf (nf×mf) is preferably equal to or greater than 2, and more preferably equal to or greater than 4.

(Molecular Weight of Fluorine-Containing Compound)

The weight-average molecular weight (Mw) of the fluorine-containing compound having a polymerizable unsaturated group can be measured using molecular exclusion chromatography, for example, gel permeation chromatography (GPC).

Mw of the fluorine-containing compound used in the present invention is preferably equal to or greater than 400 and less than 50,000, more preferably equal to or greater than 400 and less than 30,000, and even more preferably equal to or greater than 400 and less than 25,000.

(Amount of Fluorine-Containing Compound Added)

The amount of the fluorine-containing compound added with respect to the total mass of the anti-scratch layer (total solid content in the composition for forming an anti-scratch layer) is preferably 0.01% to 5% by mass, more preferably 0.1% to 5% by mass, even more preferably 0.5% to 5% by mass, and particularly preferably 0.5% to 2% by mass.

The film thickness of the anti-scratch layer is preferably 0.1 μm to 4 μm, more preferably 0.1 μm to 2 μm, and particularly preferably 0.1 μm to 1 μm.

(Adhesive Layer)

The hardcoat film according to the embodiment of the present invention may be a hardcoat film further containing an adhesive layer between the hardcoat layer and the substrate. That is, the hardcoat film according to the embodiment of the present invention may have an adhesive layer between the substrate and the hardcoat layer. The adhesive layer is a layer provided for sticking the hardcoat layer and the substrate together.

As the adhesive constituting the adhesive layer, any of appropriate forms of adhesives can be adopted. Specific examples thereof include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet-curable adhesive, and a visible light-curable adhesive. Among the above, a water-based adhesive and an active energy ray-curable adhesive can be suitably used. Specific examples of the water-based adhesive include an isocyanate-based adhesive, a polyvinyl alcohol-based adhesive (PVA-based adhesive), a gelatin-based adhesive, a vinyl-based adhesive, a latex-based adhesive, water-based polyurethane, and water-based polyester. Specific examples of the active energy ray-curable adhesive include a (meth)acrylate-based adhesive. Examples of curable components in the (meth)acrylate-based adhesive include a compound having a (meth)acryloyl group. Specific examples of the active energy ray-curable adhesive also include a compound having a vinyl group. As a cationic polymerization-curable adhesive which is one of the active energy ray-curable adhesives, a compound having an epoxy group or an oxetanyl group can also be used. The compound having an epoxy group is not particularly limited as long as it has at least two epoxy groups in a molecule. Various generally known curable epoxy compounds can be used as this compound. As the epoxy compounds, for example, a compound having at least two epoxy groups and at least one aromatic ring in a molecule (aromatic epoxy compound), a compound which has at least two epoxy groups in a molecule and in which at least one of the epoxy groups is formed between two adjacent carbon atoms constituting an alicyclic ring (alicyclic epoxy compound), and the like are preferable. Specific examples of the thermosetting adhesive include a phenol resin, an epoxy resin, a polyurethane-type curable resin, a urea resin, a melamine resin, an acrylic reactive resin, and the like. Specific examples thereof include bisphenol F-type epoxide.

In one embodiment, as the adhesive constituting the aforementioned adhesive layer, a PVA-based adhesive is used. In a case where the PVA-based adhesive is used, even though materials that do not transmit active energy rays are used, it is possible to stick the materials together. In another embodiment, as the adhesive constituting the aforementioned adhesive layer, an active energy ray-curable adhesive is used. In a case where the active energy ray-curable adhesive is used, even a material which has a hydrophobic surface and is unstickable with a PVA adhesive can obtain sufficient delamination force.

Specific examples of the adhesive include an adhesive described in JP2004-245925A that contains an epoxy compound having no aromatic ring in a molecule and is cured by heating or active energy ray irradiation, an active energy ray-curable adhesive described in JP2008-174667A that contains (a) (meth) acrylic compound having two or more (meth)acryloyl groups in a molecule, (b) (meth)acrylic compound having a hydroxyl group in a molecule and having only one polymerizable double bond, and (c) phenol ethylene oxide-modified acrylate or nonylphenol ethylene oxide-modified acrylate in a total of 100 parts by mass of the (meth)acrylic compound, and the like.

In a range equal to or lower than 70° C., the storage modulus of the adhesive layer is preferably equal to or higher than 1.0×10⁶ Pa, and more preferably equal to or higher than 1.0×10⁷ Pa. The upper limit of the storage modulus of the adhesive layer is, for example, 1.0×10¹⁰ Pa.

Typically, the thickness of the adhesive layer is preferably 0.01 μm to 7 μm, and more preferably 0.01 μm to 5 μm.

Being positioned between the hardcoat layer and the substrate, the adhesive layer greatly affects hardness. Therefore, In a case where a pressure sensitive adhesive is used instead of the adhesive layer of the present invention, sometimes hardness is significantly reduced. From the viewpoint of the hardness of the present invention, it is preferable that the adhesive layer be thin and have a high storage modulus.

For the active energy ray-curable adhesive, the choice of initiator or photosensitizer is also important. Specifically, the (meth)acrylate-based adhesive is described, for example, in Examples of JP2018-017996A. The cationic polymerization-curable adhesive can be prepared with reference to the descriptions in JP2018-035361A and JP2018-041079A.

It is preferable that the PVA-based adhesive contain an additive that improves the adhesiveness to the substrate or the hardcoat layer. The type of additive is not particularly limited, but it is preferable to use a compound containing, for example, boronic acid, or the like.

From the viewpoint of inhibiting interference fringes, a difference in a refractive index between the adhesive layer and the hardcoat layer is preferably equal to or less than 0.05, and more preferably equal to or less than 0.02. The method of adjusting the refractive index of the adhesive layer is not particularly limited. In order to reduce the refractive index, it is preferable to add hollow particles. In order to increase the refractive index, it is preferable to add zirconia particles or the like. More specifically, for example, JP2018-017996A describes specific examples of adhesives having a refractive index of 1.52 to 1.64.

From the viewpoint of the photocoloration resistance of the hardcoat film, it is preferable to incorporate an ultraviolet absorber into the adhesive layer. In a case where an ultraviolet absorber is added to the adhesive layer, from the viewpoint of bleed out or curing inhibition, it is preferable to add the ultraviolet absorber to a thermosetting adhesive.

(Ultraviolet Absorber)

Examples of the ultraviolet absorber include a benzotriazole compound, a triazine compound, and a benzoxazine compound. The benzotriazole compound is a compound having a benzotriazole ring, and specific examples thereof include various benzotriazole-based ultraviolet absorbers described in paragraph “0033” of JP2013-111835A. The triazine compound is a compound having a triazine ring, and specific examples thereof include various triazine-based ultraviolet absorbers described in paragraph “0033” of JP2013-111835A. As the benzoxazine compound, for example, those described in paragraph “0031” of JP2014-209162A can be used. The content of the ultraviolet absorber in the adhesive layer is, for example, about 0.1 to 10 parts by mass with respect to 100 parts by mass of the polymer contained in the adhesive, but is not particularly limited. Regarding the ultraviolet absorber, paragraph “0032” of JP2013-111835A can also be referred to. In the present invention, an ultraviolet absorber having high heat resistance and low volatility is preferable. Examples of such an ultraviolet absorber include UVSORB101 (manufactured by FUJIFILM Finechemicals Co., Ltd.), TINUVIN 360, TINUVIN 460, and TINUVIN 1577 (manufactured by BASF SE), LA-F70, LA-31, and LA-46 (manufactured by ADEKA CORPORATION), and the like.

From the viewpoint of forming the mixed layer which will be described later, the adhesive preferably contains a compound having a molecular weight equal to or lower than 500, and more preferably contains a compound having a molecular weight equal to or lower than 300. Furthermore, from the same viewpoint, the adhesive preferably contains a component having an SP value of 21 to 26. The SP value (solubility parameter) in the present invention is a value calculated by Hoy's method. The Hoy's method is described in POLYMERHANDBOOK FOURTH EDITION.

From the viewpoint of forming the mixed layer which will be described later, it is preferable that the adhesive for forming the adhesive layer have high affinity with the substrate. The affinity between the substrate and the adhesive can be checked by observing the change of the substrate shown in a case where the substrate is immersed in the adhesive. It is preferable to use an adhesive in which the substrate turns cloudy or is dissolved in a case where the substrate is immersed in the adhesive, because such an adhesive can effectively form the mixed layer which will be described later.

(Mixed Layer)

In a case where the hardcoat film according to the embodiment of the present invention has the adhesive layer described above, it is preferable that a mixed layer in which a component of the adhesive and a component of the substrate are mixed together be formed between the adhesive layer and the substrate layer.

The mixed layer refers to a region between the adhesive layer and the substrate, in which the compound distribution (components of the adhesive layer and components of the substrate) gradually changes from the adhesive layer side to the substrate layer side. In this case, the adhesive layer refers to a portion which contains only the components of the adhesive layer and does not contain the components of the substrate, and the substrate refers to a portion which does not contain the components of the adhesive layer. When the film is cut with a microtome, and the cross section is analyzed using a time-of-flight secondary ion mass spectrometer (TOF-SIMS), a portion is found where the components of both the substrate and adhesive layer are detected, and this portion can be measured as the mixed layer. The film thickness of this region can also be measured from the information on the cross section obtained using TOF-SIMS.

The thickness of the mixed layer is preferably 0.1 to 10.0 μm, and more preferably 1.0 μm to 6.0 μm. It is preferable that the thickness of the mixed layer be equal to or greater than 0.1 μm, because then lightfast adhesion (adhesion between the hardcoat layer and the substrate after ultraviolet irradiation) is effectively improved, and the lightfast adhesion between the hardcoat layer and the substrate can remain excellent even in a case where ultraviolet irradiation is performed for a long period time. It is preferable that the thickness of the mixed layer be equal to or less than 10.0 μm, because then excellent hardness is obtained. Furthermore, it is more preferable that the thickness of the mixed layer be equal to or less than 6.0 μm, because then excellent hardness can be maintained.

[Method for Manufacturing a Hardcoat Film]

The method for manufacturing a hardcoat film according to the embodiment of the present invention will be described.

The hardcoat film according to the embodiment of the present invention is preferably a manufacturing method including the following steps (I) and (II).

(I) Step of coating a substrate with a composition for forming a hardcoat layer containing the polyorganosilsesquioxane (A) so as to form a coating film

(II) Step of performing a curing treatment on the coating film so as to form a hardcoat layer

<Step (I)>

The step (I) is a step of coating a substrate with a composition for forming a hardcoat layer containing the polyorganosilsesquioxane (A) so as to form a coating film.

The substrate is as described above.

The composition for forming a hardcoat layer is a composition used for forming a hardcoat layer.

The composition for forming a hardcoat layer is generally in the form of a liquid. Furthermore, the composition for forming a hardcoat layer is preferably prepared by dissolving or dispersing the polyorganosilsesquioxane (A) and various optional additives and an optional polymerization initiator in an appropriate solvent. At this time, the concentration of solid contents is generally about 10% to 90% by mass, preferably 20% to 80% by mass, and particularly preferably about 40% to 70% by mass.

(Polymerization Initiator)

The polyorganosilsesquioxane (A) has a polymerizable group. In order to proceed to curing by the reaction of the polymerizable group, the composition for forming a hardcoat layer may contain a radical polymerization initiator and/or a cationic polymerization initiator. One kind of polymerization initiator may be used singly, or two or more kinds of polymerization initiators having different structures may be used in combination. Furthermore, the polymerization initiator may be a photopolymerization initiator or a thermal polymerization initiator.

The content of the polymerization initiator in the composition for forming a hardcoat layer is not particularly limited and may be appropriately adjusted within a range in which the polymerization reaction of the polyorganosilsesquioxane (A) excellently proceeds. For example, the content of the polymerization initiator with respect to 100 parts by mass of the polyorganosilsesquioxane (A) is preferably 0.1 to 200 parts by mass, and more preferably 1 to 50 parts by mass.

The composition for forming a hardcoat layer may further contain one or more kinds of optional components. Specific examples of the optional components include a solvent and various additives.

(Solvent)

As the solvent that can be contained as an optional component, an organic solvent is preferable. One kind of organic solvent can be used singly, or two or more kinds of organic solvents can be used by being mixed together at any ratio. Specific examples of the organic solvent include alcohols such as methanol, ethanol, propanol, n-butanol, and i-butanol; ketones such as acetone, methyl isobutyl ketone, methyl ethyl ketone, and cyclohexanone; cellosolves such as ethyl cellosolve; aromatic solvents such as toluene and xylene; glycol ethers such as propylene glycol monomethyl ether; acetic acid esters such as methyl acetate, ethyl acetate, and butyl acetate; diacetone alcohol; and the like. The amount of the solvent in the aforementioned composition can be appropriately adjusted within a range in which the coating suitability of the composition can be ensured. For example, the amount of the solvent with respect to the total amount (100 parts by mass) of the polyorganosilsesquioxane (A) and the polymerization initiators can be 50 to 500 parts by mass, and preferably can be 80 to 200 parts by mass.

(Additives)

If necessary, the aforementioned composition can optionally contain one or more kinds of known additives. Examples of such additives include a polymerization inhibitor, an ultraviolet absorber, an antioxidant, an antistatic agent, and the like. For details of these, for example, paragraphs “0032” to “0034” of JP2012-229412A can be referred to. However, the additives are not limited to these, and it is possible to use various additives that can be generally used in a polymerizable composition. Furthermore, the amount of the additives added to the composition is not particularly limited and may be appropriately adjusted.

<Method of Preparing Composition>

The composition for forming a hardcoat layer used in the present invention can be prepared by simultaneously mixing together the various components described above or sequentially mixing together the various components described above in any order. The preparation method is not particularly limited, and the composition can be prepared using a known stirrer or the like.

As the method of coating a substrate with the composition for forming a hardcoat layer, known methods can be used without particular limitation. Examples thereof include a dip coating method, an air knife coating method, a curtain coating method, a roller coating method, a wire bar coating method, a gravure coating method, a die coating method, and the like.

<Step (II)>

The step (II) is a step of performing a curing treatment on the coating film (i) so as to form a hardcoat layer.

The coating film is preferably cured by being irradiated with ionizing radiation or cured by heat.

The type of ionizing radiation is not particularly limited, and examples thereof include X-rays, electron beams, ultraviolet, visible light, infrared, and the like. Among these, ultraviolet is preferably used. For example, in a case where the coating film can be cured by ultraviolet, it is preferable to irradiate the coating film with ultraviolet from an ultraviolet lamp at an irradiation dose of 10 mJ/cm² to 2,000 mJ/cm² so that the curable compound is cured. The irradiation dose is more preferably 50 mJ/cm² to 1,800 mJ/cm², and even more preferably 100 mJ/cm² to 1,500 mJ/cm². As the ultraviolet lamp, a metal halide lamp, a high-pressure mercury lamp, or the like is suitably used.

In a case where the coating film is cured by heat, the temperature is not particularly limited, but is preferably equal to or higher than 80° C. and equal to or lower than 200° C., more preferably equal to or higher than 100° C. and equal to or lower than 180° C., and even more preferably equal to or higher than 120° C. and equal to or lower than 160° C.

The oxygen concentration during curing is preferably 0% to 1.0% by volume, more preferably 0% to 0.1% by volume, and most preferably 0% to 0.05% by volume. Particularly, in a case where a polymer (1) or the polyorganosilsesquioxane (A) contains (meth)acrylate as a polymerizable group, by setting the oxygen concentration during curing to be less than 1.0% by volume, curing is hardly inhibited by oxygen, and a hard film is obtained.

If necessary, a drying treatment may be performed. The drying treatment can be performed by blowing hot air, disposing the film in a heating furnace, transporting the film in a heating furnace, and the like. The heating temperature is not particularly limited and may be set to a temperature at which the solvent can be dried and removed. The heating temperature means the temperature of hot air or the internal atmospheric temperature of the heating furnace.

The present invention also relates to an article having the above hardcoat film according to the embodiment of the present invention described above and an image display device having the hardcoat film according to the embodiment of the present invention described above (preferably an image display device having the hardcoat film according to the embodiment of the present invention as a surface protection film). The hardcoat film according to the embodiment of the present invention is particularly preferably applied to flexible displays in smartphones and the like.

[Method for Manufacturing Hardcoat Film Having Adhesive Layer]

The method for manufacturing a hardcoat film having an adhesive layer will be described.

The method for manufacturing a hardcoat film having an adhesive layer according to the embodiment of the present invention is not particularly limited. For example, one of the preferred aspects thereof is a method of forming at least one hardcoat layer on a temporary support and then transferring the hardcoat layer to a substrate from the temporary support via an adhesive layer (aspect A). Another preferred aspect is, for example, a method of forming at least one hardcoat layer on a temporary support, then transferring the hardcoat layer to a protective film from the temporary support, and then transferring the hardcoat layer to a substrate from the protective film via an adhesive layer (aspect B).

Hereinafter, the aspect A will be specifically described. The aspect A is specifically a manufacturing method including the following steps (1), (2), (4), and (5).

A method for manufacturing a hardcoat film having a step (1) of coating a temporary support with a composition for forming a hardcoat layer, drying the composition, and then curing the composition so that at least one hardcoat layer is formed on the temporary support,

a step (2) of laminating a substrate on one side of the hardcoat layer that is opposite to the temporary support via an adhesive,

a step (4) of performing heating or active energy ray irradiation so that the hardcoat layer and the substrate stick together, and

a step (5) of peeling the temporary support from the hardcoat layer,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

In the aspect A, it is preferable that the manufacturing method have a step (3) of impregnating the substrate with a part of the adhesive, between the step (2) and the step (4). That is, the aspect A is preferably a manufacturing method including the following steps (1) to (5).

Step (1): a step of coating a temporary support with a composition for forming a hardcoat layer, drying the composition, and then curing the composition so that at least one hardcoat layer is formed on the temporary support.

Step (2): a step of laminating a substrate on a side of the hardcoat layer that is opposite to the temporary support via an adhesive

Step (3): a step of impregnating the substrate with a part of the adhesive

Step (4): a step of performing heating or active energy ray irradiation so that the hardcoat layer and the substrate stick together

Step (5): a step of peeling the temporary support from the hardcoat layer

<Step (1)>

The step (1) is a step of coating a temporary support with a composition for forming a hardcoat layer, drying the composition, and then curing the composition so that at least one hardcoat layer is formed on the temporary support. The step (1) is the same step as the step (I) and the step (II) except that the substrate is replaced with a temporary support.

(Temporary Support)

The temporary support is not particularly limited as long as it has a smooth surface. It is preferable that the temporary support have a flat surface having a surface roughness of about equal to or lower than 30 nm and be not difficult to be coated with the composition for forming a hardcoat layer. Temporary supports consisting of various materials can be used. For example, a polyethylene terephthalate (PET) film or a cycloolefin-based resin film is preferably used.

In the present invention, the surface roughness is measured using SPA-400 (manufactured by Hitachi High-Tech Science Corporation.) under the measurement conditions of a measurement range of 5 μm×5 μm, a measurement mode: DFM, and a measurement frequency: 2 Hz.

<Step (2)>

The step (2) is a step of laminating a substrate on a side of the hardcoat layer that is opposite to the temporary support via an adhesive.

The adhesive used is as described above. The method of providing the adhesive layer is not particularly limited. For example, it is possible to use a method of passing the film obtained by the step (1) between nip rollers while injecting an adhesive into the space between the substrate and the side of the hardcoat layer that is opposite to the temporary support so that an adhesive layer having a uniform thickness is provided, a method of uniformly coating the substrate or the side of the hardcoat layer that is opposite to the temporary support with an adhesive and then bonding another film thereto, and the like.

(Surface Treatment)

If necessary, it is preferable to perform a surface treatment on the side of the hardcoat layer that is opposite to the temporary support or on the surface of the substrate before the step (2) is performed.

Examples of the surface treatment performed in this case include a method of modifying the film surface by a corona discharge treatment, a glow discharge treatment, an ultraviolet irradiation treatment, a flame treatment, an ozone treatment, an acid treatment, an alkali treatment, or the like. The aforementioned glow discharge treatment may be a treatment with a low-temperature plasma generated in a gas at a low pressure ranging from 10⁻³ to 20 Torr. As the glow discharge treatment, a plasma treatment under atmospheric pressure is also preferable. A plasma-excited gas refers to a gas that is plasma-excited under the above conditions. Examples thereof include fluorocarbons such as argon, helium, neon, krypton, xenon, nitrogen, carbon dioxide, and tetrafluoromethane, mixtures of these, and the like. Details of these are described on pages 30 to 32 of Journal of Technical Disclosure No. 2001-1745 of Japan Institute of Invention and Innovation (issued on Mar. 15, 2001, Japan Institute of Invention and Innovation), and can be preferably used in the present invention. Among these treatments, a plasma treatment and a corona discharge treatment are preferable.

<Step (3)>

The step (3) is a step of impregnating the substrate with a part of the adhesive. Although the step (3) may not be carried out, it is preferable to perform this step because in a case where the substrate is impregnated with a part of the adhesive layer, the lightfast adhesion of the hardcoat film can be improved. How easily the substrate is impregnated with the adhesive in the step (3) varies with the type of substrate used. Therefore, the ease of impregnation can be appropriately adjusted by the components of the adhesive and the process. For example, the mixed layer can be adjusted by the process by means of controlling the temperature and time of the step (3). The longer the time of the step (3) and the higher the temperature, the further the impregnation of the substrate with the adhesive layer can be facilitated. The temperature and time of the step (3) are not particularly limited. For example, the temperature is 30° C. to 200° C. (preferably 40° C. to 150° C.). Furthermore, the time is, for example, 30 seconds to 5 minutes (preferably 1 minute to 4 minutes).

<Step (4)>

The step (4) is a step of performing heating or active energy ray irradiation so that the hardcoat layer and the substrate stick together.

The method of sticking the hardcoat layer and the substrate together is not particularly limited, and can be appropriately changed depending on the components of the adhesive layer used. Examples of the method include removing solvents (water, an alcohol, and the like) by heating in a case where the adhesive layer is a polyvinyl alcohol-based adhesive, active energy ray irradiation in a case where the adhesive layer is an active energy ray-curable adhesive, and thermal curing by heating in a case where the adhesive layer is a thermosetting adhesive. The type of active energy rays is not particularly limited, and examples thereof include X-rays, electron beams, ultraviolet, visible light, infrared, and the like. Among these, ultraviolet is preferably used. The surface to be irradiated with the active energy rays in the step (4) is not particularly limited, and can be determined depending on the transmittance of the active energy rays used in each member. The curing conditions for the ultraviolet curing are the same as the hardcoat layer curing conditions described above.

<Step (5)>

The step (5) is a step of peeling the temporary support from the hardcoat layer.

The peeling force applied to peel the temporary support from the hardcoat layer in the step (5) can be quantified by cutting the laminate obtained in the step (4) in a width of 25 mm, fixing the substrate side of the laminate to a glass substrate by using a pressure sensitive adhesive, and measuring the peeling force applied to peel off the laminate at a speed of 300 mm/min at an angle of 90°. The peeling force measured by the above method is preferably 0.1 N/25 mm to 10.0 N/25 mm, and more preferably 0.2 N/25 mm to 8.0 N/25 mm. In a case where the peeling force is less than 0.1 N/25 mm, the hardcoat layer is peeled from the temporary support in steps other than the step (5) and causes troubles. On the other hand, in a case where the peeling force is higher than 10.0 N/25 mm, the hardcoat layer partially remains on the temporary support in the step (5), or the adhesive layer is peeled off, which results in defects. The peeling force between the temporary support and the hardcoat layer varies with the type of temporary support or hardcoat layer used. Therefore, the peeling force can be appropriately adjusted. For example, the peeling force is adjusted by a method of using a temporary support having undergone a release treatment, a method adding a peeling-facilitating compound to the composition for forming a hardcoat layer, or the like. Specific examples of the peeling-facilitating compound include a compound having a long-chain alkyl group, a fluorine-containing compound, a silicone-containing compound, and the like.

(Surface Treatment)

After the step (5), a surface treatment may be performed on a surface of the hardcoat layer that is opposite to the substrate. The type of surface treatment is not particularly limited, and examples thereof include treatments for imparting antifouling properties, fingerprint resistance, and lubricity. In the aspect A described above, during the formation of the hardcoat layer, the temporary support is in a portion that will be the uppermost surface of a hardcoat layer. Therefore, sometimes the aforementioned fluorine-containing compound or a leveling agent cannot be sufficiently localized on the uppermost surface. In this case, it is preferable to perform the above treatment, because then water repellency and scratch resistance required for the hardcoat surface can be imparted.

Hereinafter, the aforementioned aspect B will be specifically described. The aspect B is specifically the following manufacturing method including the following steps (1′), (A), (B), (2′), and (4′).

A method for manufacturing a hardcoat film having a step (1′) of coating a temporary support with a composition for forming a hardcoat layer, drying the composition, and then curing the composition so that at least one hardcoat layer is formed on the temporary support,

a step (A) of bonding a protective film to one side of the hardcoat layer that is opposite to the temporary support,

a step (B) of peeling the temporary support from the hardcoat layer,

a step (2′) of laminating a substrate on one side of the hardcoat layer that is opposite to the protective film via an adhesive, and

a step (4′) of performing heating or active energy ray irradiation so that the hardcoat layer and the substrate stick together,

in which the hardcoat layer contains a compound having a silsesquioxane structure,

in a case where σA represents a modulus of elasticity of the substrate and σB represents a modulus of elasticity of the hardcoat layer, a difference Δσ of a modulus of elasticity represented by σA−σB is 1,800 to 4,900 MPa,

the modulus of elasticity of the substrate is 6.0 to 9.0 GPa, and

a recovery rate of the hardcoat layer in an indentation test that is represented by the following equation is 84% to 99%.

$$Recovery rate ( \% ) = \frac{Maximum indentation depth ( μm ) - Depth after unloading ( μm )}{Maximumin indentation depth ( μm )} \times 100$$

The aspect B is preferably a method for manufacturing a hardcoat film having a step (3′) of impregnating the substrate with a part of the adhesive, between the step (2′) and the step (4′).

The aspect B is preferably a method for manufacturing a hardcoat film having a step (5′) of peeling the protective film from the hardcoat layer.

That is, the aspect B is particularly preferably a manufacturing method including the following steps (1′), (A), (B), and (2′) to (5′).

Step (1′): a step of coating a temporary support with a composition for forming a hardcoat layer, drying the composition, and then curing the composition so that at least one hardcoat layer is formed on the temporary support.

Step (A): a step of bonding a protective film to a side of the hardcoat layer that is opposite to the temporary support

Step (B): a step of peeling the temporary support from the hardcoat layer

Step (2′): a step of laminating a film substrate containing a polyimide resin, a polyamide imide resin, or an aramid resin on a side of the hardcoat layer that is opposite to the protective film via an adhesive

Step (3′): a step of impregnating the substrate with a part of the adhesive layer

Step (4′): a step of performing heating or active energy ray irradiation so that the hardcoat layer and the film substrate stick together

Step (5′): a step of peeling the protective film from the hardcoat layer

<Step (1′)>

The step (1′) is the same step as the step (1) of the aspect A. In the step (1′), in a case where the hardcoat film includes two or more hardcoat layers or in a case where the hardcoat film includes other layers described above in addition to the hardcoat layer, the specific constitution thereof is not particularly limited as in the step (1). However, in the step (1′), from the viewpoint of scratch resistance, it is preferable that an anti-scratch layer be laminated at the end.

<Step (A)>

The step (A) is a step of bonding a protective film on a side of the hardcoat layer that is opposite to the temporary support. The protective film refers to a laminate composed of support/pressure sensitive adhesive layer. It is preferable that the pressure sensitive adhesive layer side of the protective film be bonded to the hardcoat layer. The protective film can be obtained by peeling a release film from a protective film with a release film consisting of support/pressure sensitive adhesive layer/release film. As the protective film with a release film, commercially available protective films with a release film can be suitably used. Specifically, examples thereof include AS3-304, AS3-305, AS3-306, AS3-307, AS3-310, AS3-0421, AS3-0520, AS3-0620, LBO-307, NBO-0424, ZBO-0421, S-362, and TFB-4T3-367AS manufactured by FUJIMORI KOGYO CO., LTD., and the like.

<Step (B)>

The step (B) is a step of peeling the temporary support from the hardcoat layer. In order to peel the temporary support from the hardcoat layer, the adhesion force between the protective film and the hardcoat layer needs to be higher than the peeling force between the temporary support and the hardcoat layer. The method of adjusting the peeling force between the temporary support and the hardcoat layer is not particularly limited. For example, by a method of using a temporary support having undergone a release treatment, the peeling force between the temporary support and the hardcoat layer can be reduced. The method of adjusting the adhesion force between the protective film and the hardcoat layer is not particularly limited. Examples thereof include a method of bonding a protective film to a semi-cured hardcoat layer in the step (A) and then curing the hardcoat layer.

<Step (2′)>

The step (2′) is the same step as the step (2) of the aspect A, except that the temporary support is replaced with a protective film.

<Step (3′)>

The step (3′) is the same step as the step (3) of the aspect A.

<Step (4′)>

The step (4′) is the same step as the step (4) of the aspect A, except that the temporary support is replaced with a protective film.

<Step (5′)>

The step (5′) is the same step as the step (5) of the aspect A, except that the temporary support is replaced with a protective film.

Although the aspect B includes more steps than the aspect A, the temporary support is not on the uppermost surface of the hardcoat during the formation of the hardcoat layer in the aspect B. Therefore, the aspect B has advantages such as ease of localizing the aforementioned fluorine-containing compound or leveling agent on the uppermost surface and ease of imparting water repellency or scratch resistance required for the hardcoat surface. In the aspect B, in a case where the water repellency and scratch resistance are insufficient, after the step (5), the same surface treatment as that in the aspect A may also be performed on a surface of the hardcoat layer that is opposite to the substrate.

### EXAMPLES

Hereinafter, the present invention will be more specifically described using examples, but the scope of the present invention is not limited thereto.

<Preparation of Substrate>

(Manufacturing of Polyimide Powder)

Under a nitrogen stream, 832 g of N,N-dimethylacetamide (DMAc) was added to a 1 L reactor equipped with a stirrer, a nitrogen injection device, a dropping funnel, a temperature controller, and a cooler, and then the temperature of the reactor was set to 25° C. Bistrifluoromethylbenzidine (TFDB) (64.046 g (0.2 mol)) was added thereto and dissolved. The obtained solution was kept at 25° C., and in this state, 31.09 g (0.07 mol) of 2,2-bis(3,4-dicarboxyphenyl)hexafluoropropane dianhydride (6FDA) and 8.83 g (0.03 mol) of biphenyltetracarboxylic dianhydride (BPDA) were added thereto, and the mixture was allowed to react by being stirred for a certain period of time. Then, 20.302 g (0.1 mol) of terephthaloyl chloride (TPC) was added thereto, thereby obtaining a polyamic acid solution with a concentration of solid contents of 13% by mass. Thereafter, 25.6 g of pyridine and 33.1 g of acetic anhydride were added to the polyamic acid solution, and the mixture was stirred for 30 minutes, further stirred at 70° C. for 1 hour, and then cooled to room temperature. Methanol (20 L) was added thereto, and the precipitated solid contents were filtered and ground. Subsequently, the ground resultant was dried in a vacuum at 100° C. for 6 hours, thereby obtaining 111 g of polyimide powder.

(Preparation of Substrate S-1)

The aforementioned polyimide powder (100 g) was dissolved in 670 g of N,N-dimethylacetamide (DMAc), thereby obtaining a 13% by mass solution. The obtained solution was cast on a stainless steel plate and dried with hot air at 130° C. for 30 minutes. Then, the film was peeled from the stainless steel plate and fixed to a frame by using pins, and the frame to which the film was fixed was put in a vacuum oven, heated for 2 hours by slowly increasing the heating temperature up to 300° C. from 100° C., and then slowly cooled. The cooled film was separated from the frame. Then, as a final heat treatment step, the film was further treated with heat for 30 minutes at 300° C., thereby obtaining a substrate S-1 having a film thickness of 30 μm consisting of a polyimide film.

<Synthesis of Polyorganosilsesquioxane>

(Synthesis of Compound (A))

In a 1,000 ml flask (reaction vessel) equipped with a thermometer, a stirrer, a reflux condenser, and a nitrogen introduction pipe, 300 mmol (73.9 g) of 2-(3,4-epoxycyclohexyl)ethyltrimethoxysilane, 7.39 g of triethylamine, and 370 g of methyl isobutyl ketone (MIBK) were mixed together under a nitrogen stream, and 73.9 g of pure water was added dropwise thereto for 30 minutes by using a dropping funnel. The reaction solution was heated to 80° C. so that a polycondensation reaction was carried out under a nitrogen stream for 10 hours.

Thereafter, the reaction solution was cooled, 300 g of a 5% by mass saline was added thereto, and the organic layer was extracted. The organic layer was washed with 300 g of 5% by mass saline and washed twice with 300 g of pure water in this order, and then concentrated under the conditions of 1 mmHg and 50° C., thereby obtaining 87.0 g of a colorless and transparent liquid product {the compound (A) as a polyorganosilsesquioxane having an alicyclic epoxy group (the compound represented by General Formula (1) in which Rb represents a 2-(3,4-epoxycyclohexyl)ethyl group, q=100, and r=0)} as an MIBK solution at a concentration of solid contents of 59.8% by mass.

As a result of analysis, the product has been found to have a number-average molecular weight of 2,050 and a molecular weight dispersity of 1.9.

Note that 1 mmHg equals about 133.322 Pa.

(Synthesis of Compound (B))

A methyl isobutyl ketone (MIBK) solution containing the compound (B) (the compound represented by General Formula (1) in which Rb represents a 3-glycidyloxypropyl group, q=100, and r=0) at a concentration of solid contents of 58.3% by mass was obtained in the same manner as in the synthesis of the compound (A), except that 2-(3,4-epoxycyclohexyl)ethyltrimethoxysilane in the synthesis of the compound (A) was changed to 3-glycidyloxypropyl trimethoxysilane.

The obtained compound (B) had a number-average molecular weight (Mn) of 2,190 and a dispersity (Mw/Mn) of 2.0.

(Synthesis of Compound (C))

In a 1,000 ml flask (reaction vessel) equipped with a thermometer, a stirrer, a reflux condenser, and a nitrogen introduction pipe, 300 mmol (66.09 g) of 3-(trimethoxysilyl)propylacrylate, 7.39 g of triethylamine, and 370 g of methyl isobutyl ketone (MIBK) were mixed together under a nitrogen stream, and 73.9 g of pure water was added dropwise thereto for 30 minutes by using a dropping funnel. The reaction solution was heated to 50° C. so that a polycondensation reaction was carried out in the atmosphere for 10 hours.

Thereafter, the reaction solution was cooled, 300 g of a 5% by mass saline was added thereto, and the organic layer was extracted. The organic layer was washed with 300 g of 5% by mass saline and washed twice with 300 g of pure water in this order, and then concentrated under the conditions of 1 mmHg and 50° C., thereby obtaining 87.0 g of a colorless and transparent liquid product {the compound (C) as a polyorganosilsesquioxane having an acryloyl group (the compound represented by General Formula (2) in which Ra represents an acryloyloxypropyl group, t=100, and u=0)} as an MIBK solution at a concentration of solid contents of 59.8% by mass.

As a result of analysis, the product has been found to have a number-average molecular weight of 1,900 and a molecular weight dispersity of 1.8.

### Example 1

<Preparation of Composition for Forming Hardcoat Layer>

(Composition HC-1 for Forming Hardcoat Layer)

A-600, a leveling agent-1, IRGACURE 127, and methyl isobutyl ketone (MIBK) were added to the MIBK solution containing the compound (C), the concentration of each of the components was adjusted to the following concentration, and the mixture was put in a mixing tank and stirred. The obtained composition was filtered through a polypropylene filter having a pore size of 0.45 μm, thereby obtaining a composition HC-1 for forming a hardcoat layer.

| | | |
|---|---|---|
| Compound (C) | 87.1 | parts by mass |
| A-600 | 10.0 | parts by mass |
| IRGACURE 127 | 2.8 | parts by mass |
| Leveling agent-1 | 0.01 | parts by mass |
| Methyl isobutyl ketone | 100.0 | parts by mass |

The compounds used in the composition for forming a hardcoat layer are as follows.
A-600: difunctional acrylate monomer (polyethylene glycol diacrylate, molecular weight: 708), manufactured by SHIN-NAKAMURA CHEMICAL CO., LTD.
IRGACURE 127 (Irg. 127): radical photopolymerization initiator, manufactured by BASF SE
Leveling agent-1: polymer having the following structure (Mw=2,000, the compositional ratio of the following repeating units is a mass ratio)

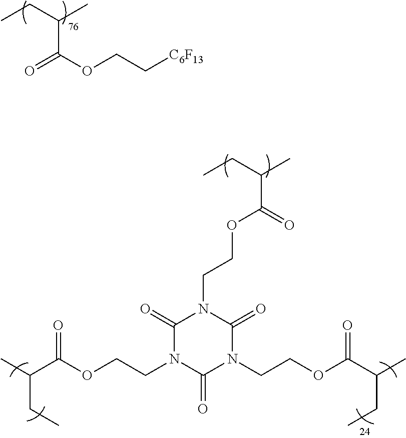

(Manufacturing of Hardcoat Film)

The polyimide substrate S-1 having a thickness of 30 μin was coated with the composition HC-1 for forming a hardcoat layer by using a #18 wire bar so that the film thickness was 12 μm after curing. After coating, the coating film was heated at 120° C. for 1 minute. Then, under the condition of an oxygen concentration lower than 100 ppm (parts per million), by using a high-pressure mercury lamp, the obtained laminate was irradiated with ultraviolet at a cumulative irradiation dose of 600 mJ/cm² and an illuminance of 60 mW/cm². Subsequently, under the conditions of 80° C. and an oxygen concentration of 100 ppm, by using an air-cooled mercury lamp, the laminate was further irradiated with ultraviolet at an illuminance of 60 mW/cm² and an irradiation dose of 600 mJ/cm² so that the hardcoat layer was fully cured. In this way, a hardcoat film 1 was obtained.

### Example 2

A hardcoat film 2 was obtained in the same manner as in Example 1, except that A-600 in the composition for forming a hardcoat layer was changed to SA1303P (UV curable group-containing polyrotaxane, (meth)acrylic equivalent: 1,000, manufactured by ASM Inc.).

### Examples 3 to 6 and Comparative Examples 1 to 4

Hardcoat films 3 and 4 of Examples 3 and 4 were obtained in the same manner as in Example 2, except that the film thickness of the hardcoat layer was changed to the film thickness described in the following Table 1.

A hardcoat film 5 of Example 5 was obtained in the same manner as in Example 1, except that the compound (A) was used instead of the compound (C), DENACOL EX830 was used instead of A-600, and CPI-110P was used instead of IRGACURE 127. In addition, a hardcoat film 6 of Example 6 was obtained in the same manner as in Example 5, except that the compound (B) was used instead of the compound (A) and DENACOL EX830 was not used.

Hardcoat films 1X to 3X of Comparative Examples 1 to 3 were obtained in the same manner as in Example 1, except that the materials described in the following Table 1 were used instead of the compound (C), A-600 was not used, and the film thickness was changed to the Film thickness described in Table 1. Furthermore, a hardcoat film 4X of Comparative Example 4 was obtained in the same manner as in Comparative Example 1, except that TAC was used as a substrate instead of S-1.

TAC used as a substrate is a cellulose acylate film 1 prepared as follows.

[Preparation of Cellulose Acylate Film 1]

(Preparation of Core Layer Cellulose Acylate Dope)

The following composition was put in a mixing tank and stirred to dissolve each component, thereby preparing a cellulose acetate solution to be used as a core layer cellulose acylate dope.

Core layer cellulose acylate dope

| | | |
|---|---|---|
| Cellulose acetate having acetyl substitution degree | 100 | parts by mass |
| of 2.88 | | |
| Polyester compound B described in Examples of | 12 | parts by mass |
| JP2015-227955A | | |
| The following compound G | 2 | parts by mass |
| Methylene chloride (first solvent) | 430 | parts by mass |
| Methanol (second solvent) | 64 | parts by mass |

Compound G

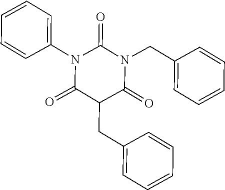 [SMILES: O=C1C(Cc2ccccc2)C(=O)N(c2ccccc2)C(=O)N1Cc1ccccc1]

(Preparation of Outer Layer Cellulose Acylate Dope)

The following matting agent solution (10 parts by mass) was added to 90 parts by mass of the aforementioned core layer cellulose acylate dope, thereby preparing a cellulose acetate solution to be used as an outer layer cellulose acylate dope.

Matting agent solution

| | | |
|---|---|---|
| Silica particles having average particle size of 20 nm | 2 | parts by mass |
| (AEROSIL R972, manufactured by Nippon Aerosil | | |
| Co., Ltd.) | | |
| Methylene chloride (first solvent) | 76 | parts by mass |
| Methanol (second solvent) | 11 | parts by mass |
| Core layer cellulose acylate dope described above | 1 | part by mass |

(Preparation of Cellulose Acylate Film 1)

The core layer cellulose acylate dope and the outer layer cellulose acylate dope described above were filtered through filter paper having an average pore size of 34 μm and a sintered metal filter having an average pore size of 10 μm. Then, the core layer cellulose acylate dope and the outer layer cellulose acylate dope on both sides of the core layer cellulose acylate dope were simultaneously cast as three layers on a drum at 20° C. from a casting outlet (band casting machine). The film was peeled off in a state where a solvent content rate thereof was about 20% by mass, both ends of the film in the width direction were fixed with tenter clips, and the film was dried while being stretched in the transverse direction at a stretching ratio of 1.1. Then, the obtained film was further dried by being transported between the rolls of a heat treatment device, thereby preparing an optical film having a thickness of 40 μm, which was used as a cellulose acylate film 1. The core layer of the cellulose acylate film 1 had a thickness of 36 μm and each of the outer layers disposed on both sides of the core layer had a thickness of 2 μm. The obtained cellulose acylate film 1 had an in-plane retardation of 0 nm at a wavelength of 550 nm.

The obtained cellulose acylate film 1 was used as a substrate.

The used components used are as below.

DENACOL EX830: difunctional aliphatic epoxy resin, manufactured by Nagase ChemteX Corporation.

DPHA: mixture of dipentaerythritol pentaacrylate and dipentaerythritol hexaacrylate, manufactured by Nippon Kayaku Co., Ltd.

DPCA20: KAYARAD DPCA20, the following compound manufactured by Nippon Kayaku Co., Ltd.

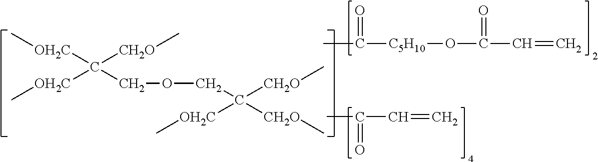

DPCA120: KAYARAD DPCA120, the following compound manufactured by Nippon Kayaku Co., Ltd.

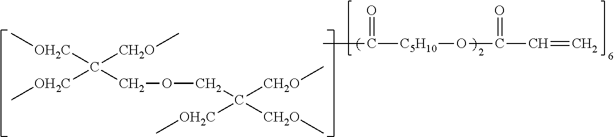

CPI-110P: Photocationic Polymerization Initiator Manufactured by San-Apro Ltd.

(Modulus of Elasticity and Recovery Rate)

By using Aron Alpha (registered trademark) (manufactured by TOAGOSEI CO., LTD.), glass was bonded to the substrate side of each hardcoat film, and then the film was measured under the following conditions by using an HM2000 hardness meter (manufactured by Fisher Instruments K.K., with Knoop indenter made of diamond).

Maximum load: 50 mN

Loading time: 10 seconds

Creep: 5 seconds

Unloading time: 10 seconds

Holding time after unloading: 60 seconds

Number of times of measurement: 10

The modulus of elasticity was calculated from an unloading curve obtained by the measurement.

Furthermore, by using the maximum indentation depth during the measurement and a depth (depth after unloading) at the end of the measurement (that is, at a point in time when the film had been held 60 seconds after unloading (0 seconds)), the recovery rate was calculated from the following equation. During the measurement, depth data was obtained every 0.1 seconds. The recovery rate was calculated using a correction value of depth obtained by subtracting an offset which is an indentation depth obtained 0.1 seconds after the start of the measurement. As each of the modulus of elasticity and the recovery rate, the average of results obtained after 10 measurement processes was used.

$$Recovery rate ( \% ) = \frac{Maximum indentation depth ( μm ) - Depth after unloading ( μm )}{Maximumin indentation depth ( μm )} \times 100$$

[Evaluation of Hardcoat Film]

The prepared hardcoat films were evaluated by the following methods.

(Pencil Hardness)

The pencil hardness of the coated surface (hardcoat layer) side was measured according to JIS K 5600-5-4 (1999).

(Folding Resistance)

Each sample was evaluated using Testing methods for paints—bend test (cylindrical mandrel) described in JIS-K-5600-5-1. Each sample was stored for 1 hour under the conditions of a temperature 25° C. and a relative humidity 55%, and then wound around mandrels having a diameter (Φ) of 2, 3, 4, 5, 6, 8, 10, 12, 14, or 16 mm with the coated surface (hardcoat layer) facing outward (the substrate facing inward). The way the cracks occurred was observed, and folding resistance was evaluated based on the diameter of the smallest mandrel that did not cause cracks. The smaller the diameter of the mandrel, the better the performance, and the larger the diameter at which cracks occur, the weaker the crack resistance. A sample in which no crack occurs at a diameter equal to or less than 6 mm has excellent folding resistance.

TABLE 1

| | Hardcoat film | | | | | Physical properties | | | | | |
|---|---|---|---|---|---|---|---|---|---|---|---|
| | | Hardcoat layer | | | | Substrate | Hardcoat layer | | | | |
| | | | | | Film | Modulus of | Modulus of | | | Evaluation | |
| | | | | | thick- | elasticity | elasticity | | Δσ = | Pencil | Folding |
| | | | | | ness | σA | σB | Recovery | σA − σB | hard- | resist- |
| | Substrate | Material | Additive | Initiator | (μm) | (MPa) | (MPa) | rate | (MPa) | ness | ance |
| Example 1 | S-1 | Compound (C) | A-600 | Irg. 127 | 12 | 8,100 | 3,400 | 88% | 4,700 | 2H | 4 mm |
| Example 2 | S-1 | Compound (C) | SA1303P | Irg. 127 | 12 | 8,100 | 4,700 | 94% | 3,400 | 3H | 4 mm |
| Example 3 | S-1 | Compound (C) | SA1303P | Irg. 127 | 5 | 8,100 | 4,700 | 94% | 3,400 | 2H | 2 mm |
| Example 4 | S-1 | Compound (C) | SA1303P | Irg. 127 | 20 | 8,100 | 4,700 | 94% | 3,400 | 4H | 6 mm |
| Example 5 | S-1 | Compound (A) | DENACOL | CPI-110P | 12 | 8,100 | 3,300 | 95% | 4,800 | 3H | 4 mm |
| | | | EX830 | | | | | | | | |
| Example 6 | S-1 | Compound (B) | — | CPI-110P | 12 | 8,100 | 3,200 | 93% | 4,900 | 3H | 4 mm |
| Comparative | S-1 | DPHA | — | Irg. 127 | 11 | 8,100 | 8,700 | 83% | −600 | 5H | 16 mm |
| Example 1 | | | | | | | | | | | |
| Comparative | S-1 | DPCA20 | — | Irg. 127 | 11 | 8,100 | 6,400 | 78% | 1,700 | 4H | 10 mm |
| Example 2 | | | | | | | | | | | |
| Comparative | S-1 | DPCA120 | — | Irg. 127 | 10 | 8,100 | 1,700 | 50% | 6,400 | H | 4 mm |
| Example 3 | | | | | | | | | | | |
| Comparative | TAC | DPHA | — | Irg. 127 | 11 | 4,300 | 8,700 | 83% | −4,400 | 3H | 16 mm |
| Example 4 | | | | | | | | | | | |

### Example 7

A Composition SR-1 for Forming an Anti-Scratch Layer was Prepared as Follows.

(Composition SR-1 for Forming Anti-Scratch Layer)

Components composed as below were put in a mixing tank, stirred, and filtered through a polypropylene filter having a pore size of 0.4 μm, thereby obtaining a composition SR-1 for forming an anti-scratch layer.

| | | |
|---|---|---|
| DPHA | 96.2 | parts by mass |
| IRGACURE 127 | 2.8 | parts by mass |
| RS-90 | 1.0 | part by mass |
| Methyl ethyl ketone | 300.0 | parts by mass |

The compounds used in the composition for forming an anti-scratch layer are as follows.

RS-90: Slip Agent, Manufactured by DIC Corporation

The substrate S-1 was coated with the composition for forming a hardcoat layer in the same manner as in Example 2, except that the hardcoat layer had a film thickness of 11 μm after curing in Example 2. By using a die coater, the obtained coating film was coated with the composition SR-1 for forming an anti-scratch layer. The obtained film was dried at 120° C. for 1 minute. Thereafter, by using an air-cooled mercury lamp, the film was irradiated with ultraviolet at an illuminance of 18 mW/cm² and an irradiation dose of 19 mJ/cm² at 25° C. under the condition of an oxygen concentration of 100 ppm, and then the hardcoat layer was coated with a 0.6 μm thick anti-scratch layer by using a die coater. After being dried at 120° C. for 1 minute, the film was irradiated with ultraviolet at an illuminance of 60 mW/cm² and an irradiation dose of 600 mJ/cm² at 25° C. under the condition of an oxygen concentration of 100 ppm. Then, under the conditions of 80° C. and an oxygen concentration of 100 ppm, the film was further irradiated with ultraviolet at an illuminance of 60 mW/cm² and an irradiation dose of 600 mJ/cm² by using an air-cooled mercury lamp. In this way, the hardcoat layer was fully cured. Thereafter, the obtained film was treated with heat at 120° C. for 1 hour, thereby obtaining a hardcoat film 7 of Example 7 having an anti-scratch layer.

Pencil hardness and folding resistance were evaluated by the method described above.

(Scratch Resistance)

By using a rubbing tester, under the following conditions, a rubbing test was performed on a surface (surface of the anti-scratch layer) of the prepared hardcoat film that was opposite to the substrate, thereby obtaining indices of scratch resistance.

Environmental conditions for evaluation: 25° C., relative humidity 60%

Rubbing Material: steel wool (NIHON STEEL WOOL Co., Ltd., grade No. 0000)

The steel wool was wound around the rubbing tip portion (2 cm×2 cm) of the tester coming into contact with the sample and fixed with a band.

Moving distance (one way): 13 cm,

Rubbing speed: 13 cm/sec,

Load: 1,000 g/cm²

Contact area of tip portion: 2 cm×2 cm,

Number of times of rubbing: rubbed back and forth 1,000 times

After the test, an oil-based black ink was applied to a surface (surface of the substrate) of the hardcoat film that was opposite to the rubbed surface (surface of the anti-scratch layer). The reflected light was visually observed, the number of times of rubbing that caused scratches in the portion contacting the steel wool was counted, and the scratch resistance was evaluated.

A: No scratch

B: Scratched

The evaluation results of scratch resistance are shown in the following Table 2. Table 2 also shows the results of the aforementioned scratch resistance test on the hardcoat layer of the hardcoat films 1X and 2X of Comparative Examples 1 and 2.

TABLE 2

| | | | Modulus of | | | | | |
|---|---|---|---|---|---|---|---|---|
| | Film | Modulus of | elasticity | | | | | |
| | thickness | elasticity | σA of | | Recovery | | | |
| | of hardcoat | σA of | hardcoat | | rate of | | | |
| | layer | substrate | layer | Δσ | hardcoat | Pencil | Folding | Scratch |
| | (μm) | (MPa) | (MPa) | (MPa) | layer | hardness | resistance | resistance |
| Example 7 | 11 | 8,100 | 4,700 | 3,400 | 94% | 4H | 6 mm | A |
| Comparative | 11 | 8,100 | 8,700 | −600 | 83% | 5H | 16 mm | B |
| Example 1 | | | | | | | | |
| Comparative | 11 | 8,100 | 6,400 | 1,700 | 78% | 4H | 10 mm | B |
| Example 2 | | | | | | | | |

### Examples 8 to 11 of Hardcoat Film Having Adhesive Layer

A composition for forming a hardcoat layer and a composition for forming an anti-scratch layer were prepared as follows.
<Preparation of Composition for Forming Hardcoat Layer
(Composition HC-2 for Forming Hardcoat Layer)
HC-2 was prepared by changing the compositional ratio of HC-1 as follows.

| | | |
|---|---|---|
| Compound (C) | 87.1 | parts by mass |
| SA1303P | 10.0 | parts by mass |
| IRGACURE 127 | 2.8 | parts by mass |
| Leveling agent-1 | 0.01 | parts by mass |
| Methyl isobutyl ketone | 100.0 | parts by mass |

<Preparation of Composition for Forming Anti-Scratch Layer>

(Composition SR-2 for Forming Anti-Scratch Layer)

SR-2 was prepared by changing the compositional ratio of SR-1 as follows.

| | | |
|---|---|---|
| DPHA | 96.2 | parts by mass |
| IRGACURE 127 | 2.8 | parts by mass |
| Leveling agent-1 | 1.0 | part by mass |
| Methyl ethyl ketone | 300.0 | parts by mass |

(Composition SR-3 for Forming Anti-Scratch Layer)
SR-3 was prepared by changing the compositional ratio of SR-1 as follows.

| | | |
|---|---|---|
| DPHA | 96.2 | parts by mass |
| RS-90 | 1.0 | part by mass |
| Compound P | 2.8 | parts by mass |
| Methyl ethyl ketone | 300.0 | parts by mass |

The compounds used in the composition for forming an anti-scratch layer are as follows. Compound P: photoacid generator represented by the following structural formula (manufactured by FUJIFILM Wako Pure Chemical Corporation)

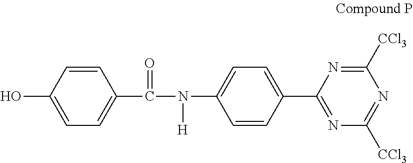

<Preparation of Adhesive>
(Ultraviolet-curable adhesive composition UV-1)
CEL2021P ⋅ ⋅ ⋅ 70.0 parts by mass
1,4-Butanediol diglycidyl ether ⋅ ⋅ ⋅ 18.0 parts by mass
2-Ethylhexyl glycidyl ether ⋅ ⋅ ⋅ 10.0 parts by mass
IRGACURE 290 2.0 parts by mass

The compounds used in the ultraviolet-curable adhesive composition are as follows.
CEL2021P: the following compound, manufactured by Daicel Corporation
IRGACURE 290: sulfonium-based photocation initiator, manufactured by BASF SE

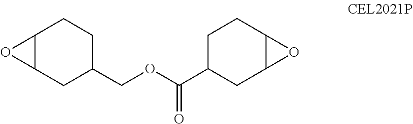 [SMILES: O=C(OCC1CCC2OC2C1)C1CCC2OC2C1]

### Example 8

<Preparation of Hardcoat Film>

(Step (1): Formation of Hardcoat Layer on Temporary Support)

By using a die coater, a 100 μm polyethylene terephthalate film (FD100M, manufactured by FUJIFILM Corporation) as a temporary support was coated with the composition SR-2 for forming an anti-scratch layer. After the composition SR-2 was dried at 120° C. for 1 minute, the anti-scratch layer was semi-cured by being irradiated with ultraviolet under the conditions of an illuminance of 18 mW/cm², an irradiation dose of 10 mJ/cm², and an oxygen concentration of 1.0% by using an air-cooled mercury lamp at 25° C. Then, by using a die coater, the surface of the anti-scratch layer that was opposite to the temporary support was coated with the composition HC-2 for forming a hardcoat layer. After the composition HC-2 was dried at 120° C. for 1 minute, the hardcoat layer was irradiated with ultraviolet under the conditions of an illuminance of 60 mW/cm², an irradiation dose of 600 mJ/cm², an oxygen concentration of 100 ppm by using an air-cooled mercury lamp at 25° C. Furthermore, by using an air-cooled mercury lamp, the obtained film was irradiated with ultraviolet at 100° C. under the conditions of an illuminance of 60 mW/cm², an irradiation dose of 600 mJ/cm², and an oxygen concentration of 100 ppm so that the anti-scratch layer and the hardcoat layer were thoroughly cured.

(Step (2): Formation of Adhesive Layer)

A corona discharge treatment was performed on the surface of the hardcoat layer prepared in the step (1) that was opposite to the anti-scratch layer. The corona discharge treatment was performed at 20 m/min using a solid-state corona discharge processor 6KVA model (manufactured by NIPPON PILLAR PACKING Co., LTD). At this time, based on the current·voltage readings, the treatment condition was set to 0.375 KV·A·min/m², the discharge frequency during the treatment was set to 9.6 KHz, and the gap clearance between an electrode and a dielectric roll was set to 1.6 mm. In a state where the ultraviolet-curable adhesive UV-1 was being injected into the space between the corona discharge-treated surface of the hardcoat layer and the substrate S-1, the corona discharge-treated surface and the substrate S-1 were overlapped and passed between nip rollers, thereby forming a laminate having a temporary support, an anti-scratch layer, a hardcoat layer, an adhesive layer, and the substrate S-1.

(Step (3): Formation of Mixed Layer)

By heating the laminate prepared in the step (2) at 80° C. for 1 minute, a mixed layer in which the components of the substrate S-1 and the components of the adhesive were mixed together was formed.

(Step (4): Sticking)

By using an air-cooled mercury lamp at 25° C., the temporary support side of the laminate having a mixed layer prepared in the step (3) was irradiated with ultraviolet under the conditions of an illuminance of 60 mW/cm² and an irradiation dose of 600 mJ/cm² so that the adhesive layer was cured and that the hardcoat layer and the substrate S-1 stuck together.

(Step (5): Peeling of Temporary Support)

From the laminate obtained in the step (4), in which the hardcoat layer and the substrate S-1 stuck together, the temporary support was peeled, thereby obtaining a hardcoat film of Example 8.

### Example 9

<Preparation of Hardcoat Film>

(Step (1): Formation of Hardcoat Layer on Temporary Support)

By using a die coater, a 100 μm polyethylene terephthalate film (FD100M, manufactured by FUJIFILM Corporation) as a temporary support was coated with the composition HC-2 for forming a hardcoat layer. After the composition HC-2 was dried at 120° C. for 1 minute, the hardcoat layer was irradiated with ultraviolet under the conditions of an illuminance of 60 mW/cm², an irradiation dose of 600 mJ/cm², an oxygen concentration of 100 ppm by using an air-cooled mercury lamp at 25° C. Furthermore, by using an air-cooled mercury lamp, the obtained film was irradiated with ultraviolet at 100° C. under the conditions of an illuminance of 60 mW/cm², an irradiation dose of 600 mJ/cm², and an oxygen concentration of 100 ppm so that the hardcoat layer was thoroughly cured.

(Step (2): Formation of Adhesive Layer)

For the hardcoat layer prepared in the step (1), a corona discharge treatment was performed on the surface of the hardcoat layer that was opposite to the temporary support side under the same conditions as in Example 8. In a state where the ultraviolet-curable adhesive UV-1 was being injected into the space between the corona discharge-treated surface of the hardcoat layer and the substrate S-1, the corona discharge-treated surface and the substrate S-1 were overlapped and passed between nip rollers, thereby forming a laminate having a temporary support, a hardcoat layer, an adhesive layer, and the substrate S-1.

(Step (3): Formation of Mixed Layer)

By heating the laminate prepared in the step (2) at 80° C. for 1 minute, a mixed layer in which the components of the substrate S-1 and the components of the adhesive were mixed together was formed.

(Step (4): Sticking)

By using an air-cooled mercury lamp at 25° C., the temporary support side of the laminate having a mixed layer prepared in the step (3) was irradiated with ultraviolet under the conditions of an illuminance of 60 mW/cm² and an irradiation dose of 600 mJ/cm² so that the adhesive layer was cured and that the hardcoat layer and the substrate S-1 stuck together.

(Step (5): Peeling of Temporary Support)

From the laminate obtained in the step (4), in which the hardcoat layer and the substrate S-1 stuck together, the temporary support was peeled, thereby obtaining a hardcoat film of Example 9.

### Example 10

A hardcoat film of Example 10 was obtained in the same manner as in Example 9, except that immediately after the film passed through the nip rollers in the step (2), the ultraviolet irradiation for sticking in the step (4) was performed without performing the step (3).

### Example 11

(Step (1′): Formation of Hardcoat Layer on Temporary Support)

By using a die coater, a release-treated surface of a non-silicone release film HP-A5 (manufactured by Fujiko Co., Ltd.) as a temporary support was coated with the composition HC-2 for forming a hardcoat layer. After the composition HC-2 was dried at 120° C. for 1 minute, by using an air-cooled mercury lamp at 25° C., the hardcoat layer was semi-cured by being irradiated with ultraviolet under the conditions of an illuminance of 18 mW/cm², an irradiation dose of 10 mJ/cm², and an oxygen concentration of 100 ppm. Then, by using a die coater, the surface of the hardcoat layer that was opposite to the temporary support was coated with the composition SR-3 for forming an anti-scratch layer. After the composition SR-3 was dried at 120° C. for 1 minute, by using an air-cooled mercury lamp at 25° C., the hardcoat layer was cured by being irradiated with ultraviolet under the conditions of an illuminance of 18 mW/cm², an irradiation dose of 10 mJ/cm², and an oxygen concentration of 1.0%.

(Step (A): Bonding of Protective Film)

A protective film obtained by peeling a release film from a protective film with a release film (MASTACK TFB AS3-304) manufactured by FUJIMORI KOGYO CO., LTD. was bonded to a side of the anti-scratch layer obtained in the step (1′) that was opposite to the hardcoat layer so that a pressure sensitive adhesive layer of the protective film faced the anti-scratch layer. The bonding was performed at a speed 1 by using a laminator Bio330 (manufactured by DAE-EL Co.) for business use. Then, in order to improve the adhesion force between the protective film and the anti-scratch layer, by using an air-cooled mercury lamp at 100° C., the protective film side was irradiated with ultraviolet at an illuminance of 60 mW/cm² and an irradiation dose of 600 mJ/cm².

(Step (B): Peeling of Temporary Support)

The temporary support was peeled from the laminate obtained in the step (A).

(Step (2′): Formation of Adhesive Layer)

For the hardcoat layer prepared in the step (B), a corona discharge treatment was performed on the surface of the hardcoat layer that was opposite to the anti-scratch layer under the same conditions as in the step (2) of Example 8. Then, in a state where the ultraviolet-curable adhesive UV-1 was being injected into the space between the corona discharge-treated surface of the hardcoat layer and the substrate S-1, the corona discharge-treated surface and the substrate S-1 were overlapped and passed between nip rollers, thereby forming a laminate having a protective film, an anti-scratch layer, a hardcoat layer, an adhesive layer, and the substrate S-1.

(Step (3′): Formation of Mixed Layer)

A mixed layer was formed in the same manner as in the step (3).

(Step (4′): sticking)

Sticking was performed in the same manner as in the step (4).

(Step (5′): protective film)

From the laminate obtained in the step (4′), the protective film was peeled, thereby obtaining a hardcoat film of Example 11.

[Calculation of Film Thickness of Each Layer of Hardcoat Film]

The film thickness of each of the hardcoat layer, anti-scratch layer, adhesive layer, and mixed layer of the prepared hardcoat film was calculated by cutting the hardcoat film with a microtome and analyzing the cross section with SEM and a time-of-flight secondary ion mass spectrometer (TOF-SIMS). The film thickness is described in Table 3. Note that the thickness of a portion where both the component of the substrate and component of the adhesive layer were detected was calculated as the thickness of the mixed layer.

The modulus of elasticity, recovery rate, pencil hardness, and folding resistance were evaluated by the methods described above. The results are described in Table 3.

TABLE 3

| | Hardcoat film | | | | | | | |
|---|---|---|---|---|---|---|---|---|
| | Anti-scratch layer | | Hardcoat layer | | | | | |
| | Composition | | Composition | | Adhesive layer | | | |
| | for | | for | | Ultraviolet- | | Mixed layer | |
| | forming | Film | forming | Film | curable | Film | | Film |
| | anti-scratch | thickness | hardcoat | thickness | adhesive | thickness | Formation | thickness |
| | layer | [μm] | layer | [μm] | composition | [μm] | condition | [μm] |
| Example 8 | SR-2 | 0.6 | HC-2 | 11.0 | UV-1 | 1.0 | 80° C., 1 | 3.0 |
| | | | | | | | minute | |
| Example 9 | — | — | HC-2 | 12.0 | UV-1 | 1.0 | 80° C., 1 | 3.0 |
| | | | | | | | minute | |
| Example 10 | — | — | HC-2 | 12.0 | UV-1 | 1.6 | — | 0.0 |
| Example 11 | SR-3 | 0.6 | HC-2 | 11.0 | UV-1 | 1.0 | 80° C., 1 | 3.0 |
| | | | | | | | minute | |

| | | Physical properties | | | | | |
|---|---|---|---|---|---|---|---|
| | | Substrate | Hardcoat layer | | | | |
| | | Modulus of | Modulus of | | | | |
| | | elasticity | elasticity | | Δσ = | evaluation | |
| | Hardcoat film | σA | σB | Recovery | σA − σB | Pencil | Folding |
| | Substrate | (MPa) | (MPa) | rate | (MPa) | hardness | resistance |
| Example 8 | S-1 | 8,100 | 4,700 | 94 | 3400 | 4H | 6 mm |
| Example 9 | S-1 | 8,100 | 4,700 | 94 | 3400 | 3H | 4 mm |
| Example 10 | S-1 | 8,100 | 4,700 | 94 | 3400 | 3H | 4 mm |
| Example 11 | S-1 | 8,100 | 4,700 | 94 | 3400 | 4H | 6 mm |

According to an aspect of the present invention, it is possible to provide a hardcoat film which has high hardness and excellent folding resistance and an article and an image display device which comprise the hardcoat film.

The present invention has been described in detail with reference to specific embodiments. To those skilled in the art, it is obvious that various changes or modifications can be added without departing from the gist and scope of the present invention.

What is claimed is:

1. A hardcoat film comprising:
a substrate; and
a hardcoat layer formed on at least one surface of the substrate,
wherein the hardcoat layer contains a compound having a silsesquioxane structure,
in a case where σA represents a modulus of elasticity of the substrate and σB represents a modulus of elasticity of the hardcoat layer, a difference Δσ of a modulus of elasticity represented by σA−σB is 1,800 to 4,900 MPa,
the modulus of elasticity of the substrate is 6.0 to 9.0 GPa, and
a recovery rate of the hardcoat layer in an indentation test that is represented by the following equation is 84% to 99%,
$$Recovery rate ( \% ) = \frac{Maximum indentation depth ( μm ) - Depth after unloading ( μm )}{Maximumin indentation depth ( μm )} \times 100.$$

2. The hardcoat film according to claim 1,
wherein a thickness of the hardcoat layer is 0.5 μm to 30 μm.

3. The hardcoat film according to claim 1,
wherein the substrate contains an imide-based polymer.

4. The hardcoat film according to claim 2,
wherein the substrate contains an imide-based polymer.

5. The hardcoat film according to claim 1,
wherein the compound having a silsesquioxane structure is a cured product of a polyorganosilsesquioxane having at least one of a (meth)acryloyl group or an epoxy group.

6. The hardcoat film according to claim 2,
wherein the compound having a silsesquioxane structure is a cured product of a polyorganosilsesquioxane having at least one of a (meth)acryloyl group or an epoxy group.

7. The hardcoat film according to claim 1,
wherein the compound having a silsesquioxane structure is a cured product of a polyorganosilsesquioxane having at least one of a (meth)acryloyl group or an epoxy group, and
a content rate of the compound having a silsesquioxane structure with respect to a total solid content of a composition for forming the hardcoat layer is equal to or higher than 50% by mass and equal to or lower than 100% by mass.

8. The hardcoat film according to claim 1,
wherein the hardcoat layer contains a compound having a polyrotaxane structure.

9. The hard coat film according to claim 8,
wherein the compound having a polyrotaxane structure is a cured product of a polyrotaxane having at least one of a (meth)acryloyl group or an epoxy group.

10. The hardcoat film according to claim 1,
wherein the hardcoat layer contains a cured product of at least one of a compound (b1) having two or more (meth)acryloyl groups in one molecule, a compound (b2) having two or more epoxy groups in one molecule, a compound (b3) having two or more oxetanyl groups in one molecule, or a blocked isocyanate compound (b4).

11. The hardcoat film according to claim 1, further comprising:
an anti-scratch layer on the hardcoat layer,
wherein the anti-scratch layer contains a cured product of at least one of a compound (c1) having two or more (meth)acryloyl groups in one molecule or a compound (c2) having two or more epoxy groups in one molecule.

12. The hardcoat film according to claim 1, further comprising:
an adhesive layer between the hardcoat layer and the substrate.

13. The hardcoat film according to claim 12, further comprising:
a mixed layer, in which a component of the adhesive layer and a component of the substrate are mixed together, between the adhesive layer and the substrate,
wherein the mixed layer has a thickness of 0.1 μm to 10 μm.

14. An article comprising:
the hardcoat film according to claim 1.

15. An image display device comprising:
the hardcoat film according to claim 1 as a surface protection film.

16. A method for manufacturing a hardcoat film comprising:
coating a temporary support with a composition for forming a hardcoat layer, drying the composition, and then curing the composition so that at least one hardcoat layer is formed on the temporary support;
laminating a substrate on one side of the hardcoat layer that is opposite to the temporary support via an adhesive to provide a laminate;
performing heating or active energy ray irradiation to the laminate so that the hardcoat layer and the substrate stick together; and
peeling the temporary support from the hardcoat layer,
wherein the hardcoat layer contains a compound having a silsesquioxane structure,
in a case where σA represents a modulus of elasticity of the substrate and σB represents a modulus of elasticity of the hardcoat layer, a difference Δσ of a modulus of elasticity represented by σA−σB is 1,800 to 4,900 MPa,
the modulus of elasticity of the substrate is 6.0 to 9.0 GPa, and
a recovery rate of the hardcoat layer in an indentation test that is represented by the following equation is 84% to 99%,
$$Recovery rate ( \% ) = \frac{Maximum indentation depth ( μm ) - Depth after unloading ( μm )}{Maximumin indentation depth ( μm )} \times 100.$$

17. The method for manufacturing a hardcoat film according to claim 16, further comprising:
impregnating the substrate in the laminate with a part of the adhesive before the heating or active energy ray irradiation.

18. A method for manufacturing a hardcoat film comprising:
coating a temporary support with a composition for forming a hardcoat layer, drying the composition, and then curing the composition so that at least one hardcoat layer is formed on the temporary support;
bonding a protective film to one side of the hardcoat layer that is opposite to the temporary support;
peeling the temporary support from the hardcoat layer;
laminating a substrate on one side of the hardcoat layer that is opposite to the protective film via an adhesive to provide a laminate; and
performing heating or active energy ray irradiation to the laminate so that the hardcoat layer and the substrate stick together,
wherein the hardcoat layer contains a compound having a silsesquioxane structure,
in a case where σA represents a modulus of elasticity of the substrate and σB represents a modulus of elasticity of the hardcoat layer, a difference Δσ of a modulus of elasticity represented by σA−σB is 1,800 to 4,900 MPa,
the modulus of elasticity of the substrate is 6.0 to 9.0 GPa, and
a recovery rate of the hardcoat layer in an indentation test that is represented by the following equation is 84% to 99%,
$$Recovery rate ( \% ) = \frac{Maximum indentation depth ( μm ) - Depth after unloading ( μm )}{Maximumin indentation depth ( μm )} \times 100.$$

19. The method for manufacturing a hardcoat film according to claim 18, further comprising:
impregnating the substrate in the laminate with a part of the adhesive before the heating or active energy ray irradiation.

20. The method for manufacturing a hardcoat film according to claim 18, further comprising:
peeling the protective film from the hardcoat layer stuck to the substrate.
